(19) United States
(12) Patent Application Publication
(10) Pub. No.: US 2018/0067210 A1
(43) Pub. Date: Mar. 8, 2018

(54) AUTONOMOUS TRAVELING APPARATUS

(71) Applicant: Sharp Kabushiki Kaisha, Osaka (JP)

(72) Inventors: Kazuhiro MATSUYAMA, Sakai City (JP); Yoshiteru KIKUCHI, Sakai City (JP); Kazuhisa YONEDA, Sakai City (JP)

(21) Appl. No.: 15/690,377

(22) Filed: Aug. 30, 2017

(30) Foreign Application Priority Data
Sep. 6, 2016 (JP) 2016-173690

(51) Int. Cl. G01S 17/02; G01S 17/88; H04N 7/18; H04N 5/33; H04N 5/232; H04N 5/225

(52) U.S. Cl. CPC G01S 17/023; G01S 17/88; H04N 7/181; H04N 5/2253; H04N 5/23238; H04N 5/2252; H04N 5/33

(57) ABSTRACT

An autonomous traveling apparatus includes a detecting device that is provided with a plurality of optical detecting units each of which detects a detection target object by using light. At least two optical detecting units out of the plurality of optical detecting units are arranged in a vertical direction.

### BACKGROUND

### 1. Field

The present disclosure relates to an autonomous traveling apparatus which includes a detecting device with a plurality of optical detecting units, each of which detects a detection target object by using light, and autonomously travels while detecting a detection target object by using the detecting device.

### 2. Description of the Related Art

In the related art, there is known a detecting device with a plurality of optical detecting units, each of which detects a detection target object by using light, (for example, refer to Japanese Unexamined Patent Application Publication No. 2015-40830) and such a detecting device is built into an autonomous traveling apparatus which autonomously travels while detecting a detection target object, for example.

However, in an autonomous traveling apparatus which includes a detecting device with a plurality of optical detecting units, each of which detects a detection target object by using light, and autonomously travels while detecting a detection target object by using the detecting device, detection ranges of the plurality of optical detecting units may limit each other although depending on the structure of a traveling apparatus body and the arrangement state of the plurality of optical detecting units. In addition, since the plurality of optical detecting units are arranged in a disorderly manner, the structure of the autonomous traveling apparatus becomes complicated.

### SUMMARY

It is desirable to provide an autonomous traveling apparatus which includes a detecting device with a plurality of optical detecting units, each of which detects a detection target object by using light, and autonomously travels while detecting a detection target object by using the detecting device and with which it is possible to suppress detection ranges of the plurality of optical detecting units being limited and to simplify the structure of the autonomous traveling apparatus.

According to an aspect of the disclosure, there is provided an autonomous traveling apparatus including a detecting device that is provided with a plurality of optical detecting units each of which detects a detection target object by using light. The autonomous traveling apparatus autonomously travels while detecting the detection target object by using the detecting device, and at least two optical detecting units out of the plurality of optical detecting units are arranged in a vertical direction.

### BRIEF DESCRIPTION OF THE DRAWINGS

FIG. 1 is a schematic front view illustrating an appearance of an autonomous traveling apparatus according to an embodiment of the disclosure;

FIG. 2 is a schematic see-through side view illustrating an internal configuration of the autonomous traveling apparatus illustrated in FIG. 1;

FIG. 3 is a schematic side view schematically illustrating the autonomous traveling apparatus illustrated in FIG. 1 and is a view illustrating a state where a lifting and lowering table has been lowered by a lifting and lowering device;

FIG. 4 is a schematic side view schematically illustrating the autonomous traveling apparatus illustrated in FIG. 1 and is a view illustrating a state where the lifting and lowering table has been lifted by the lifting and lowering device;

FIG. 5 is a schematic perspective view illustrating an area including optical detecting units of the autonomous traveling apparatus illustrated in FIG. 1 as seen in an oblique direction from an upper right area on the front surface side;

FIG. 6 is a schematic enlarged perspective view illustrating an area including the optical detecting units of the autonomous traveling apparatus illustrated in FIG. 5 in which a first optical detecting unit covering portion is illustrated with imaginary lines;

FIG. 7 is a schematic perspective view illustrating an area including the optical detecting units of the autonomous traveling apparatus illustrated in FIG. 6 as seen in an oblique direction from an upper left area on the front surface side in a state where an optical detecting unit covering portion has been removed;

FIG. 8 is a schematic perspective view illustrating an area including the optical detecting units of the autonomous traveling apparatus illustrated in FIG. 7 as seen in an oblique direction from an upper right area on the front surface side;

FIG. 9 is a schematic perspective view illustrating the optical detecting unit covering portion as seen in an oblique direction from an upper area on the front surface side;

FIG. 10 is a schematic perspective view illustrating the optical detecting unit covering portion as seen in an oblique direction from a lower right area on the rear surface side;

FIG. 11 is a schematic perspective view illustrating the first optical detecting unit covering portion as seen in an oblique direction from a right upper area on the front surface side;

FIG. 12 is a schematic perspective view illustrating the first optical detecting unit covering portion as seen in an oblique direction from a lower right area on the rear surface side;

FIG. 13A is a front view of the first optical detecting unit covering portion;

FIG. 13B is a rear view of the first optical detecting unit covering portion;

FIG. 13C is a top view of the first optical detecting unit covering portion;

FIG. 13D is a bottom view of the first optical detecting unit covering portion;

FIG. 13E is a left side view of the first optical detecting unit covering portion;

FIG. 13F is a sectional view of the first optical detecting unit covering portion which is taken along line XIIIF-XIIIF in FIG. 13C;

FIG. 14 is a schematic perspective view illustrating a second optical detecting unit covering portion as seen in an oblique direction from a lower right area on the front surface side;

FIG. 15A is a front view of the second optical detecting unit covering portion;

FIG. 15B is a rear view of the second optical detecting unit covering portion;

FIG. 15C is a top view of the second optical detecting unit covering portion;

FIG. 15D is a bottom view of the second optical detecting unit covering portion; and

FIG. 15E is a left side view of the second optical detecting unit covering portion.

### DESCRIPTION OF THE EMBODIMENTS

Hereinafter, embodiments of the disclosure will be described with reference to drawings.

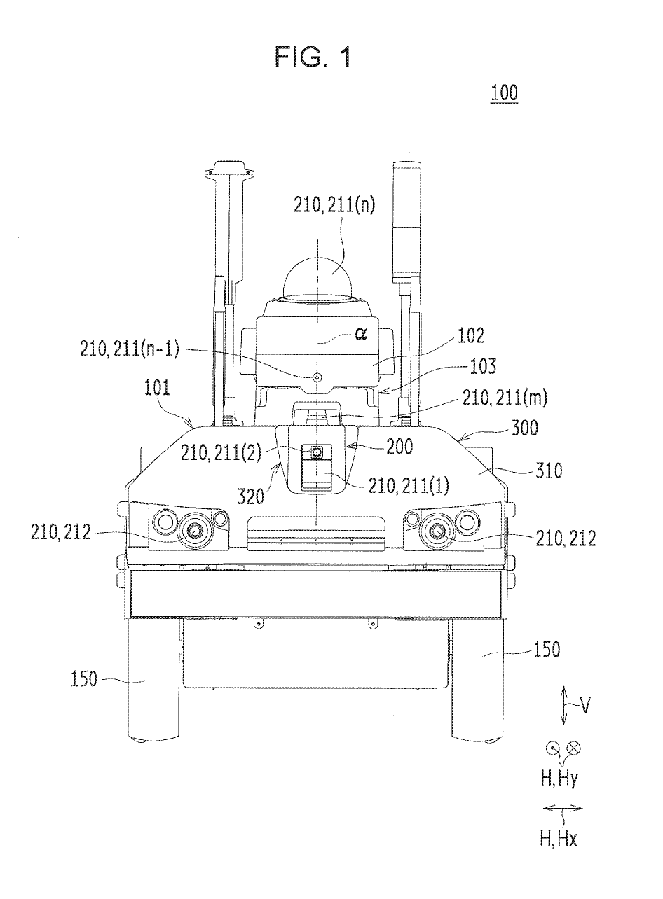

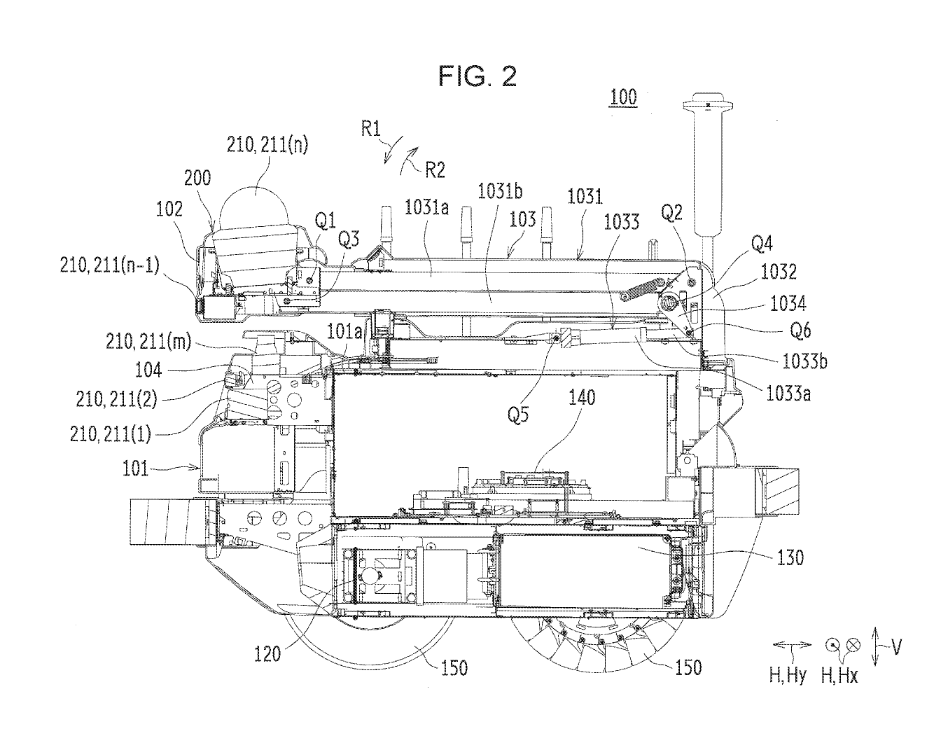

FIG. 1 is a schematic front view illustrating an appearance of an autonomous traveling apparatus 100 according to an embodiment of the disclosure. FIG. 2 is a schematic see-through side view illustrating an internal configuration of the autonomous traveling apparatus 100 illustrated in FIG. 1.

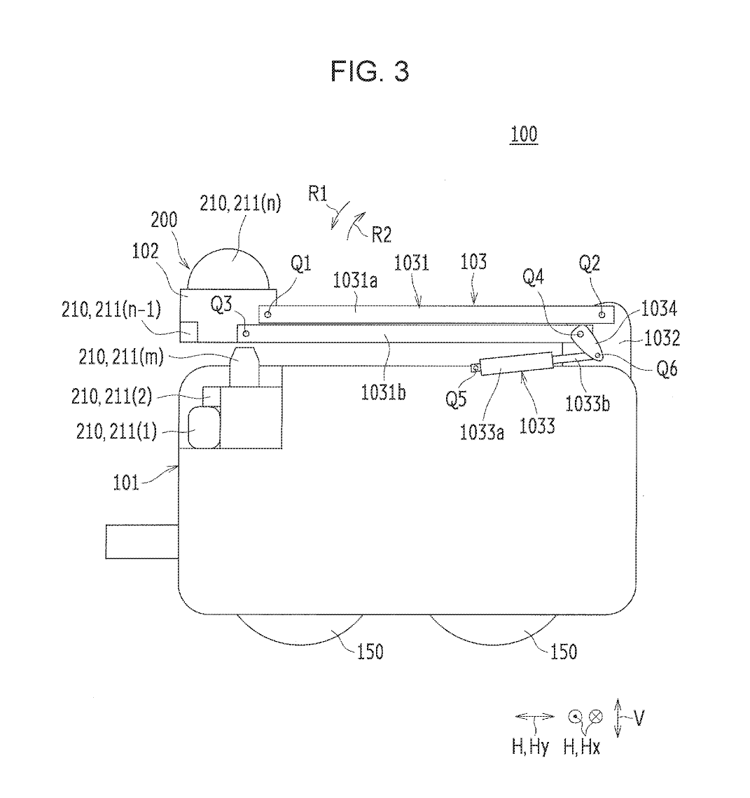

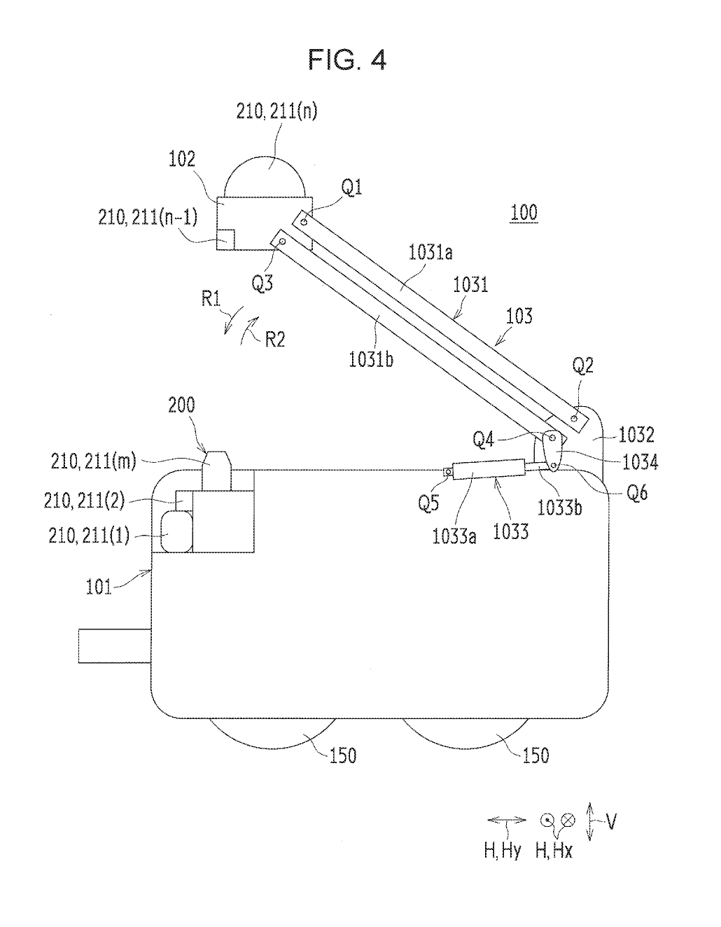

FIGS. 3 and 4 are schematic side views schematically illustrating the autonomous traveling apparatus 100 illustrated in FIG. 1. FIG. 3 is a view illustrating a state where a lifting and lowering table 102 has been lowered by a lifting and lowering device 103 and FIG. 4 is a view illustrating a state where the lifting and lowering table 102 has been lifted by the lifting and lowering device 103.

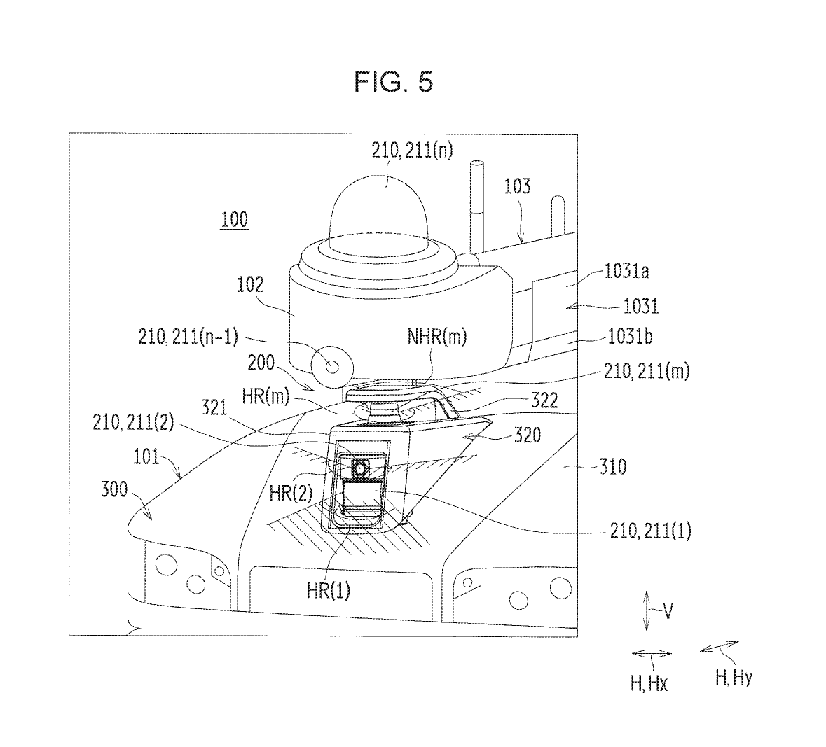

In addition, FIG. 5 is a schematic perspective view illustrating an area including optical detecting units 211 to 211 of the autonomous traveling apparatus 100 illustrated in FIG. 1 as seen in an oblique direction from an upper right area on the front surface side.

As illustrated in FIGS. 1 to 5, the autonomous traveling apparatus 100 includes a detecting device 200 and autonomously travels while detecting a detection target object by using the detecting device 200. The detecting device 200 includes a plurality of detecting units 210 to 210 each of which detects a detection target object. Here, the detection target object includes any substance that can be a detection target and it is a matter of course that the detection target object includes living creatures such as a person and an animal.

Each of the plurality of detecting units 210 to 210 detects a detection target object within a detection range that is set in advance (specifically, a detection range in a horizontal direction H, a detection range in a vertical direction V, or a detection range in both of the horizontal direction H and the vertical direction V).

The plurality of detecting units 210 to 210 include the plurality of optical detecting units 211 to 211 each of which detects a detection target object by using light.

Specifically, the autonomous traveling apparatus 100 is a vehicle with a three or four or more wheels (in this example, four wheels) that moves along a predetermined route that is set in advance. The autonomous traveling apparatus 100 includes a driving source provided in the autonomous traveling apparatus 100 (in this example, an electric motor 120 (refer to FIG. 2)), an energy supplying source (in this example, a power source 130 (refer to FIG. 2)), and a control device 140 (refer to FIG. 2). The autonomous traveling apparatus 100 is driven by the driving source with energy being supplied from the energy supplying source. In this example, the power source 130 is a rechargeable battery and a lithium ion battery, a nickel hydrogen battery, a nickel-cadmium (Ni—Cd) battery, a lead battery, a fuel cell, an air cell, and the like can be used as the power source 130. The power source 130 supplies electric power for realizing a traveling function, a distance detecting function, and a communication function in many cases.

It is possible to change both or one of the advancing speed and the advancing direction of the autonomous traveling apparatus 100 by controlling vehicle wheels 150 to 150 (refer to FIGS. 1 to 4) by using an instruction signal from the control device 140. In this example, it is possible to change the advancing direction of the autonomous traveling apparatus 100 by controlling wheels on the right side (150 and 150) and wheels on the left side (150 and 150) individually and making the rotation speeds thereof different and it is possible to cause the autonomous traveling apparatus 100 to turn without a change in position (a fixed position turn) by causing the wheels on the right side and the wheels on the left side to rotate in opposite directions. The autonomous traveling apparatus 100 travels straight on toward the front side (the front side in FIG. 1 and the left side in FIGS. 2 to 4) in many cases. The configuration of the autonomous traveling apparatus 100 is not limited to this and the number of the vehicle wheels 150 to 150 may be changed and a belt or the like may be provided.

Such an autonomous traveling apparatus 100 can be used as, for example, a monitoring robot that monitors a monitoring target such as a suspicious person or a suspicious object (the detection target object) while communicating with a monitoring center.

Meanwhile, in an autonomous traveling apparatus in the related art, detection ranges of a plurality of optical detecting units may limit each other although depending on the structure of a traveling apparatus body and the arrangement state of the plurality of optical detecting units. In addition, since the plurality of optical detecting units are arranged in a disorderly manner, the structure of the autonomous traveling apparatus becomes complicated.

In this regard, in the embodiment, at least two or at least three optical detecting units 211 (1) to 211 (n) (where n is an integer of 2 or 3 or more) (in this example, n=5) out of the plurality of optical detecting units 211 to 211 are arranged in the vertical direction V.

In this manner, detection ranges of at least two or at least three optical detecting units 211 (1) to 211 (n) can be arranged in the vertical direction V. Therefore, it is possible to suppress the detection ranges of at least two or at least three optical detecting units 211 (1) to 211 (n) being limited. Furthermore, it is possible to simplify the structure of the autonomous traveling apparatus 100.

In addition, the detection accuracy of the optical detecting units may be deteriorated in a case where the plurality of the optical detecting units are arranged in a disorderly manner. However, since the detection ranges of the optical detecting units 211 (1) to 211 (n) can be arranged in the vertical direction V, it is possible to efficiently suppress deterioration in detecting accuracy of the optical detecting units 211 (1) to 211 (n).

Specifically, the optical detecting units 211 (1) to 211 (n) are arranged in parallel such that the optical detecting units 211 (1) to 211 (n) are positioned on a vertical plane α (refer to FIG. 1) extending along the vertical direction V (that is, optical detecting units 211 (1) to 211 (n) and the vertical plane α overlap each other). In this example, the vertical plane α extends along the vertical direction V and a front-rear direction Hy. The optical detecting units 211 (1) to 211 (n) are provided on the front surface side (the front side) of the autonomous traveling apparatus 100. In addition, the optical detecting units 211 (1) to 211 (n) are arranged in parallel such that the central points of detecting elements (sensors) thereof pass through the vertical plane α as seen in a predetermined direction (in this example, from the front surface side).

Here, as the optical detecting unit, any optical detecting unit that detects a detection target object by using light can be used. Examples of the optical detecting unit include a light detection and ranging device (or a laser imaging detection and ranging device) (a Lidar device) which specifies the position of a detection target object, the distance to the detection target object, and the shape of the detection target object through irradiation of a light beam (specifically, laser light) and an imaging camera (a photographing camera).

Representative examples of the Lidar device include a two-dimensional Lidar device (so-called 2D Lidar device) which detects a detection target object within a detection range in the horizontal direction H and a three-dimensional Lidar device (so-called 3D Lidar device) which detects a detection target object within a detection range in both of the horizontal direction H and the vertical direction V. Each of the two-dimensional Lidar device and the three-dimensional Lidar device can detect a detection target object in real time by using both or one of a moving image and a still image, for example.

In addition, representative examples of the imaging camera include a camera provided with an imaging element such as a charge coupled device (CCD) image sensor and a complementary metal oxide semiconductor (CMOS) image sensor which are sensitive to visible light. The imaging camera can image a detection target object in real time by using both or one of a moving image and a still image, for example. The imaging camera may be a camera that captures an image by using both or one of infrared light and ultraviolet light instead of visible light or in addition to visible light.

### First Embodiment

In a first embodiment, two or more optical detecting units 211 (1) to 211(m) out of the optical detecting units 211 (1) to 211 (n) arranged in the vertical direction V may be different from each other in detecting structure for detecting the detection target object (where m is an integer of 2 or more) (in this example, m=3).

In this case, it is possible to detect various detection target objects by a plurality of detection methods which are different from each other and thus it is possible to recognize a detection target object at high accuracy.

The detection ranges in the horizontal direction H of the optical detecting units 211 (1) to 211 (n) may be different from each other. However, if the optical detecting units are arranged in the vertical direction V in a state where the widths of the detection ranges are random, the detection ranges in the horizontal direction H of the optical detecting units 211 (1) to 211 (n) are likely to limit each other. Therefore, it is desirable to make the detection ranges HR (1) to HR (n) in the horizontal direction H of the optical detecting units 211 (1) to 211 (n) be likely to limit each other.

In this regard, in the first embodiment, two or more optical detecting units 211 (1) to 211 (m) (in this example, m=3) out of the optical detecting units 211 (1) to 211 (n) arranged in the vertical direction V may be arranged such that detection ranges HR (1) to HR (m) (refer to FIG. 5) thereof in the horizontal direction H become wider from one side toward the other side in the vertical direction V.

In this case, the two or more optical detecting units 211 (1) to 211 (m) can be arranged such that detection ranges HR (1) to HR (m) thereof in the horizontal direction H become wider from one side toward the other side in the vertical direction V. Therefore, it is possible to make the detection ranges HR (1) to HR (m) in the horizontal direction H of the two or more optical detecting units 211 (1) to 211 (m) be unlikely to limit each other.

The detection range HR (1) in the horizontal direction H of the optical detecting unit 211 (1) which is closest to the one side out of the two or more optical detecting unit 211 (1) to 211 (m) is the narrowest and there may be a case where no detection range in the horizontal direction H is provided as the detection range HR (1).

Meanwhile, as the height of a detection position of each of the optical detecting units 211 (1) to 211 (m) increases, the field of view becomes wider so that a detection target object far away can be detected. Accordingly, it is desirable to arrange the optical detecting units 211 (1) to 211 (m) in the vertical direction V such that the optical detecting units 211 (1) to 211 (m) detect a detection target object with fields of view thereof in the horizontal direction H becoming wider from the lower side to the upper side.

In this regard, in the first embodiment, the two or more optical detecting units 211 (1) to 211 (m) may be arranged such that detection ranges HR (1) to HR (m) thereof in the horizontal direction H become wider from the lower side toward the upper side.

In this case, the two or more optical detecting units 211 (1) to 211 (m) can detect a detection target object with the fields of view thereof in the horizontal direction H becoming wider toward the upper side.

In the first embodiment, central positions or approximately central positions of the detection ranges HR (1) to HR (m) in the horizontal direction H of the two or more optical detecting units 211 (1) to 211 (m) may be aligned with each other in the vertical direction V.

In this case, it is possible for each of the optical detecting units 211 (1) to 211 (m) to reliably detect a detection target object.

Specifically, the central positions or the approximately central positions of the detection ranges HR (1) to HR (m) in the horizontal direction H of the two or more optical detecting units 211 (1) to 211 (m) are arranged in parallel such that the central positions or the approximately central positions of the detection ranges HR (1) to HR (m) are positioned on the vertical plane α.

In the first embodiment, the optical detecting units 211 (1) to 211 (n) arranged in the vertical direction V may include two Lidar devices (in this example, a three-dimensional Lidar device 211 (1) and a two-dimensional Lidar device 211 (3)) and an imaging camera 211 (2).

If the two Lidar devices (in this example, the three-dimensional Lidar device 211 (1) and the two-dimensional Lidar device 211 (3)) detect a detection target object while being positioned close to each other, light beams (specifically, laser light) may interfere with each other and the detecting accuracies of the two Lidar devices may be deteriorated. Therefore, it is desirable to improve the detecting accuracies of the two Lidar devices.

In this regard, in the first embodiment, the imaging camera 211 (2) may be disposed between the two Lidar devices (in this example, between the three-dimensional Lidar device 211 (1) and the two-dimensional Lidar device 211 (3)).

In this case, since the imaging camera 211 (2) is disposed between the two Lidar devices (in this example, between the three-dimensional Lidar device 211 (1) and the two-dimensional Lidar device 211 (3)), it is possible to separate the two Lidar devices away from each other. Therefore, it is possible to suppress light beams (specifically, laser light) from the two Lidar device interfering with each other and thus it is possible to improve the detecting accuracies of the two Lidar devices.

In this example, the three-dimensional Lidar device 211 (1), the imaging camera 211 (2), and the two-dimensional Lidar device 211 (3) are arranged in this order in a direction from one side to the other side in the vertical direction V.

In the first embodiment, the two Lidar devices may be the three-dimensional Lidar device and the two-dimensional Lidar device, and the three-dimensional Lidar device 211 (1), the imaging camera 211 (2), and the two-dimensional Lidar device 211 (3) may be arranged in this order in a direction from the lower side to the upper side such that detection ranges thereof in the horizontal direction H become wider from the lower side toward the upper side.

In this case, the imaging camera 211 (2) can detect a detection target object with a wider field of view in the horizontal direction H than the three-dimensional Lidar device 211 (1) and the two-dimensional Lidar device 211 (3) can detect a detection target object with a wider field of view in the horizontal direction H than the imaging camera 211 (2).

In this example, the detection ranges HR (1), HR (2), and HR (3) in the horizontal direction H of the three-dimensional Lidar device 211 (1), the imaging camera 211 (2), and the two-dimensional Lidar device 211 (3) are a 60-degree range, a 197-degree range, and a 270-degree range, respectively. The detection ranges in the vertical direction H of the three-dimensional Lidar device 211 (1) and the imaging camera 211 (2) are a 50-degree range and a 120-degree range, respectively.

### Second Embodiment

Examples of the optical detecting unit further include an infrared camera (a so-called infrared (IR) camera) and an omnidirectional camera.

Representative examples of the infrared camera include an infrared imaging camera provided with an infrared detecting element which is sensitive to infrared light. The infrared imaging camera can image a detection target object (an imaging target object) in real time by using both or one of a moving image and a still image, for example. Examples of infrared detecting element include an indium gallium arsenide (InGaAs) element (with a sensible wavelength range of approximately 0.9 μm to 1.7 μm, for example), an indium antimonide (InSb) element (with a sensible wavelength range of approximately 1.5 μm to 5 μm, for example), and a microbolometer (with a sensible wavelength range of approximately 7 μm to 14 μm, for example).

In addition, the omnidirectional camera is a camera that can perform an imaging operation over the whole circumference in the horizontal direction H and may be a camera of which a non-imaging area is both or one of a partial area including an area immediately above the camera and a partial area including an area immediately below the camera.

Examples of the omnidirectional camera include an omnidirectional imaging camera in which a single imaging camera rotates in the horizontal direction H or in a direction approximately parallel to the horizontal direction H (rotating around a rotation axis that extends along the vertical direction V or in a direction approximately parallel to the vertical direction V), an omnidirectional imaging camera provided with a single imaging fisheye camera (for example, a fisheye lens with an angle of view in the vertical direction V exceeding 180 degrees), and an omnidirectional imaging camera in which a plurality of imaging cameras are arranged in parallel such that angles of view of the imaging cameras overlap each other and the imaging cameras are positioned radially and uniformly in the horizontal direction. The omnidirectional imaging camera can image a detection target object (an imaging target object) in real time by using both or one of a moving image and a still image, for example.

In the first embodiment, the optical detecting units 211 (1) to 211 (n) arranged in the vertical direction V may further include an infrared camera 211 (4) and an omnidirectional camera 211 (5). In this example, the infrared camera 211 (4) and the omnidirectional camera 211 (5) are provided on the front side of the autonomous traveling apparatus 100.

Meanwhile, since the infrared camera is suitable for an in-dark place imaging operation (for example, an at-night imaging operation) and the omnidirectional camera can perform an imaging operation over the whole circumference in the horizontal direction, it is desirable that any of the infrared camera and the omnidirectional camera is disposed at a high position.

In this regard, the infrared camera 211 (4) and the omnidirectional camera 211 (5) may be provided above other optical detecting units (in this example, the three-dimensional Lidar device 211 (1), the imaging camera 211 (2) and the two-dimensional Lidar device 211 (3)) out of the optical detecting units 211 (1) to 211 (n) arranged in the vertical direction V (that is, above optical detecting units other than the infrared camera 211 (4) and the omnidirectional camera 211 (5)).

In this case, it is possible for the infrared camera 211 (4) to perform an in-dark place imaging operation (for example, an at-night imaging operation) with respect to a detection target object (an imaging target object) with a wide field of view at a high position and it is possible for the omnidirectional camera 211 (5) to image a detection target object (an imaging target object) over the whole circumference in the horizontal direction at a high position.

In the second embodiment, the infrared camera 211 (4) and the omnidirectional camera 211 (5) may be arranged in this order in a direction from the lower side to the upper side.

In this case, it is possible for the omnidirectional camera 211 (5) to reliably image a detection target object (an imaging target object) over the whole circumference in the horizontal direction H at a higher position than the infrared camera 211 (4).

Meanwhile, in a case where the infrared camera 211 (4) and the omnidirectional camera 211 (5) image a detection target object (an imaging target object) positioned higher than a traveling apparatus body 101, it may be difficult for the infrared camera 211 (4) and the omnidirectional camera 211 (5) to sufficiently image the detection target object (the imaging target object). Therefore, to improve imaging functions of the infrared camera 211 (4) and the omnidirectional camera 211 (5), it is desirable that the infrared camera 211 (4) and the omnidirectional camera 211 (5) are disposed at higher positions.

In this regard, in the second embodiment, the autonomous traveling apparatus 100 may further include the traveling apparatus body 101 that is provided with two or more optical detecting units 211 (1) to 211(m) out of the optical detecting units 211 (1) to 211 (n) arranged in the vertical direction V (in this example, m=3), the lifting and lowering table 102, and the lifting and lowering device 103 that lifts and lowers the lifting and lowering table 102 with respect to the traveling apparatus body 101.

Specifically, the lifting and lowering device 103 are provided on an upper portion of the traveling apparatus body 101 of the autonomous traveling apparatus 100.

The lifting and lowering device 103 includes a parallel link mechanism 1031 (refer to FIGS. 2 to 5), a rotation supporting portion 1032 (refer to FIGS. 2 to 4), a driving unit 1033 (refer to FIGS. 2 to 4), and a connecting member 1034 (refer to FIGS. 2 to 4).

The parallel link mechanism 1031 supports the lifting and lowering table 102 and lifts and lowers the lifting and lowering table 102 while keeping the lifting and lowering table 102 upright with respect to the horizontal direction or a direction approximately parallel to the horizontal direction. The parallel link mechanism 1031 includes a first supporting arm 1031a and a second supporting arm 1031b (refer to FIGS. 2 to 5) which are elongated in the horizontal direction H or a direction approximately parallel to the horizontal direction H (in this example, the front-rear direction Hy or a direction approximately parallel to the front-rear direction Hy) in a state where the lifting and lowering table 102 has been lowered.

One end portion of the first supporting arm 1031a supports the lifting and lowering table 102 and the other end of the first supporting arm 1031a is supported by the traveling apparatus body 101. Specifically, the one end portion of the first supporting arm 1031a supports the lifting and lowering table 102 such that the lifting and lowering table 102 can rotate around a first rotation axis (specifically, a first rotation shaft Q1 (refer to FIGS. 2 to 4)) that extends in the horizontal direction H (in this example, a transverse direction Hx). The other end portion of the first supporting arm 1031a is supported by the traveling apparatus body 101 such that the 1031a can rotate around a second rotation axis (specifically, a second rotation shaft Q2 (refer to FIGS. 2 to 4)) that extends in the horizontal direction H (in this example, the transverse direction Hx).

The second supporting arm 1031b is positioned below the first supporting arm 1031a. One end portion of the second supporting arm 1031b supports the lifting and lowering table 102 and the other end of the second supporting arm 1031b is supported by the traveling apparatus body 101. Specifically, the one end portion of the second supporting arm 1031b supports the lifting and lowering table 102 such that the lifting and lowering table 102 can rotate around a third rotation axis (in this example, a third rotation shaft Q3 which is closer to the front side than the first rotation shaft Q1 is (refer to FIGS. 2 to 4)) that extends in the horizontal direction H (in this example, the transverse direction Hx). The other end portion of the second supporting arm 1031b is supported by the traveling apparatus body 101 such that the 1031b can rotate around a fourth rotation axis (specifically, a fourth rotation shaft Q4 which is closer to the front side than the second rotation shaft Q2 is (refer to FIGS. 2 to 4)) that extends in the horizontal direction H (in this example, the transverse direction Hx).

The rotation supporting portion 1032 supports a base end portion of the parallel link mechanism 1031 such that the parallel link mechanism 1031 can rotate around a rotation axis that extends in the horizontal direction H.

The driving unit 1033 drives the parallel link mechanism 1031 to lift and lower the parallel link mechanism 1031. The driving unit 1033 is provided with a driving unit body 1033a which is supported by the traveling apparatus body 101 (refer to FIGS. 2 to 4) and a movable portion 1033b that advances and retreats with respect to the driving unit body 1033a (refer to FIGS. 2 to 4). Examples of the driving unit 1033 include a pressure cylinder such as a hydraulic cylinder, a gas cylinder, and an air cylinder.

In addition, the connecting member 1034 connects the parallel link mechanism 1031 and the driving unit 1033 to each other. One end portion of the connecting member 1034 rotates around the second rotation axis (specifically, the second rotation shaft Q2) along with the first supporting arm 1031a or rotates around the fourth rotation axis (specifically, the fourth rotation shaft Q4) along with the second supporting arm 1031b. In this example, the one end portion of the connecting member 1034 is fixed to the second supporting arm 1031b and rotates integrally with the second supporting arm 1031b. A base end portion of the driving unit body 1033a of the driving unit 1033 is supported by the traveling apparatus body 101 such that the base end portion can rotate around a fifth rotation axis (specifically, a fifth rotation shaft Q5 (refer to FIGS. 2 to 4)) that extends in the horizontal direction H (in this example, the transverse direction Hx). A distal end portion of the movable portion 1033b of the driving unit 1033 is connected to the other end portion of the connecting member 1034 such that the distal end portion can rotate around a sixth rotation axis (specifically, a sixth rotation shaft Q6 (refer to FIGS. 2 to 4)) that extends in the horizontal direction H (in this example, the transverse direction Hx).

In the lifting and lowering device 103 having a configuration as described above, the parallel link mechanism 1031 is rotated in a first rotation direction R1 (refer to FIGS. 2 to 4), which is a closing direction extending around the second rotation axis (specifically, the second rotation shaft Q2) and the fourth rotation axis (specifically, the fourth rotation shaft Q4), when the movable portion 1033b of the driving unit 1033 is caused to protrude from the driving unit body 1033a. As a result, the lifting and lowering table 102 is rotated in the first rotation direction R1 with respect to the parallel link mechanism 1031 and thus the lifting and lowering table 102 can be lowered with the lifting and lowering table 102 being kept upright with respect to the horizontal direction or a direction approximately parallel to the horizontal direction (refer to FIG. 3). On the other hand, the parallel link mechanism 1031 is rotated in a second rotation direction R2 (refer to FIGS. 2 to 4), which is an opening direction extending around the second rotation axis (specifically, the second rotation shaft Q2) and the fourth rotation axis (specifically, the fourth rotation shaft Q4), when the movable portion 1033b of the driving unit 1033 is drawn into the driving unit body 1033a. As a result, the lifting and lowering table 102 is rotated in the second rotation direction R2 with respect to the parallel link mechanism 1031 and thus the lifting and lowering table 102 can be lifted with the lifting and lowering table 102 being kept upright with respect to the horizontal direction or a direction approximately parallel to the horizontal direction (refer to FIG. 4).

In addition, the infrared camera 211 (4) and the omnidirectional camera 211 (5) may be provided on the lifting and lowering table 102.

In this case, the infrared camera 211 (4) and the omnidirectional camera 211 (5) can be disposed at further higher positions. Therefore, it is possible for the infrared camera 211 (4) and the omnidirectional camera 211 (5) to reliably image a detection target object (an imaging target object) even in a case where the infrared camera 211 (4) and the omnidirectional camera 211 (5) image a detection target object (an imaging target object) positioned higher than the traveling apparatus body 101.

Note that, the plurality of detecting units 210 to 210 include one ultrasonic wave detecting unit 210 (212) or a plurality of (in this example, two) ultrasonic wave detecting units 210 (212) and 210 (212) (refer to FIG. 1). In this example, the ultrasonic wave detecting units 210 (212) and 210 (212) are provided in the right and left areas on the front side of the traveling apparatus body 101. In addition, the plurality of optical detecting units 211 to 211 include three imaging cameras (not shown) that have the same function as the imaging camera 211 (2) in addition to the imaging camera 211 (2). The three imaging cameras are provided on the right side, the rear surface side (the rear side), and the left side of the traveling apparatus body 101, respectively.

In addition, a cover member 300 and the like which are illustrated in FIGS. 1 and 5 will be described later.

### Third Embodiment

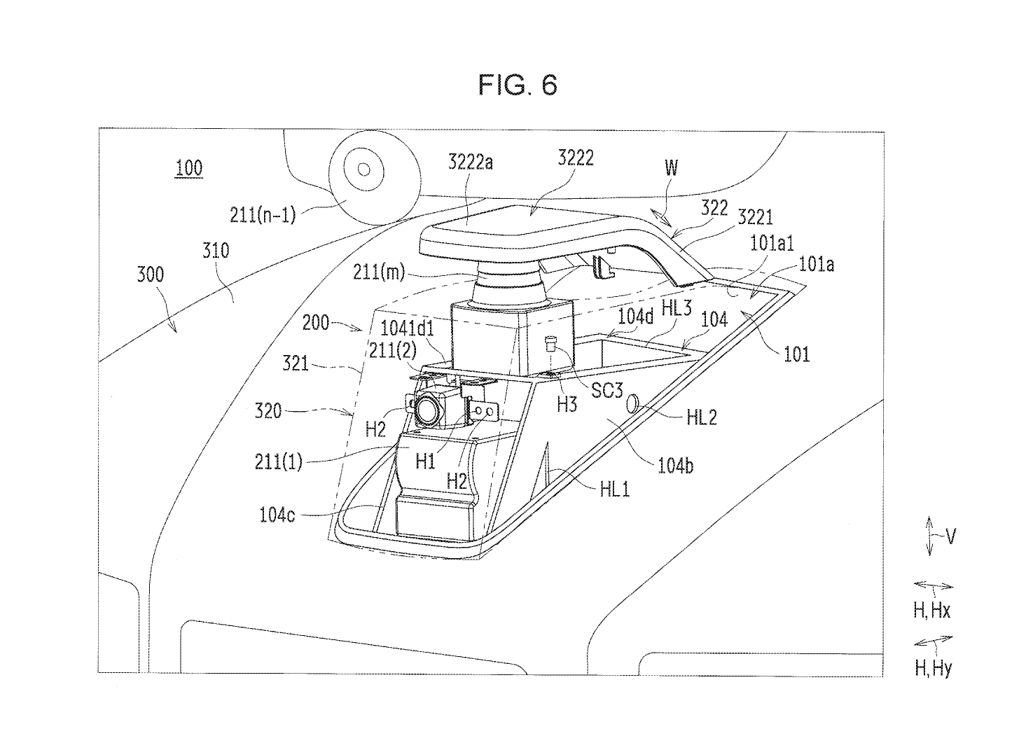

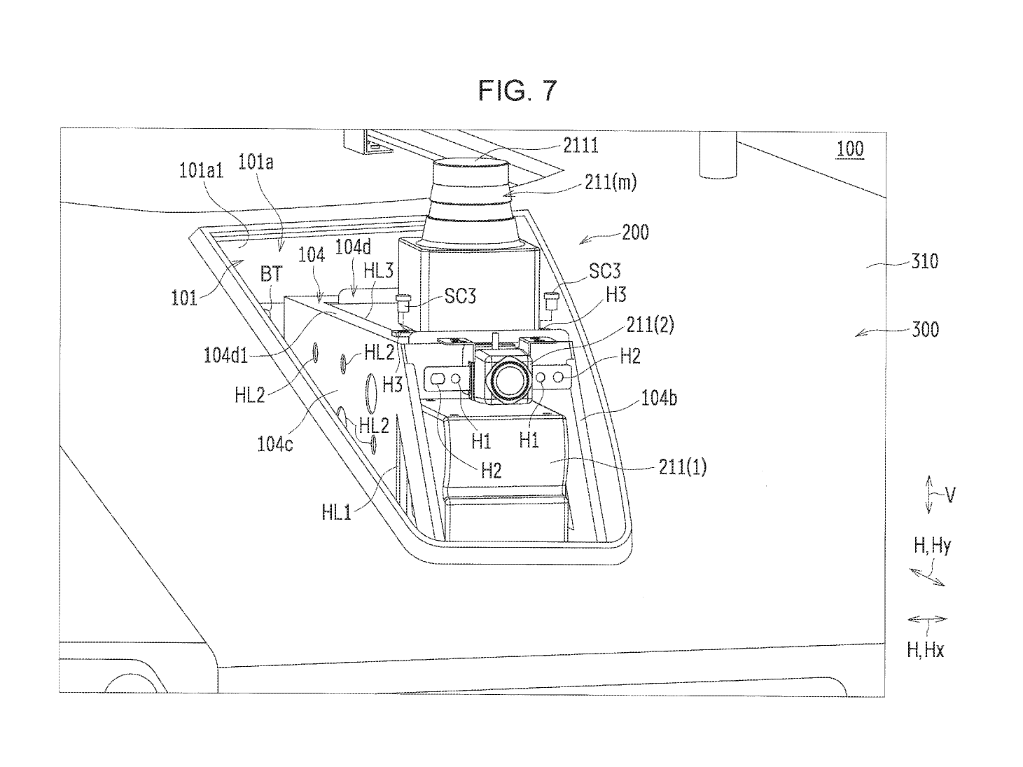

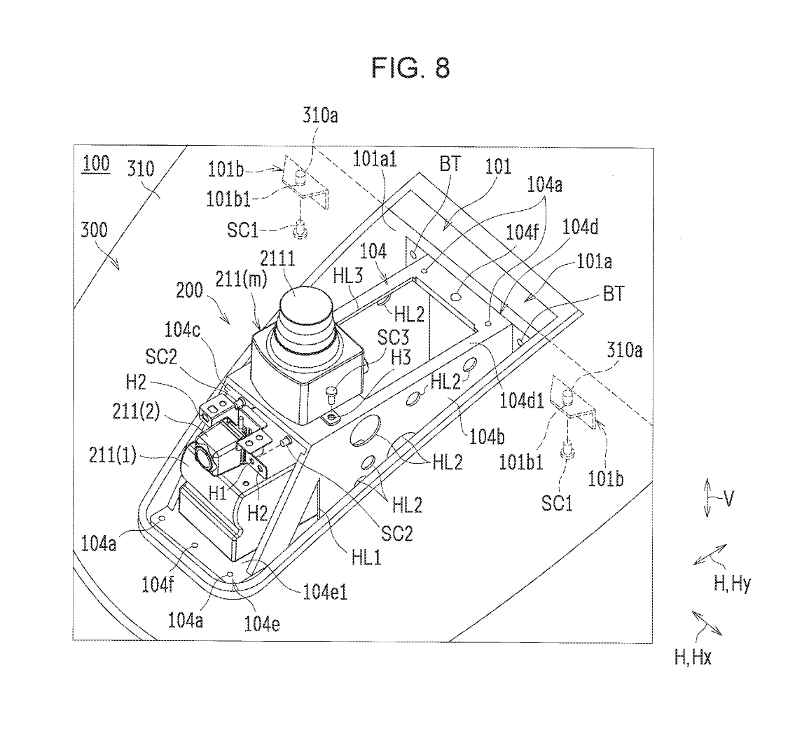

FIG. 6 is a schematic enlarged perspective view illustrating an area including the optical detecting units 211 (1) to 211 (n) of the autonomous traveling apparatus 100 illustrated in FIG. 5 in which a first optical detecting unit covering portion 321 is illustrated with imaginary lines. FIG. 7 is a schematic perspective view illustrating an area including the optical detecting units 211 (1) to 211 (n) of the autonomous traveling apparatus 100 illustrated in FIG. 6 as seen in an oblique direction from an upper left area on the front surface side in a state where an optical detecting unit covering portion 320 has been removed. FIG. 8 is a schematic perspective view illustrating an area including the optical detecting units 211 (1) to 211 (n) of the autonomous traveling apparatus 100 illustrated in FIG. 7 as seen in an oblique direction from an upper right area on the front surface side. In FIG. 6, the omnidirectional camera 211 (5) is not illustrated and in FIGS. 7 and 8, the infrared camera 211 (4) and the omnidirectional camera 211 (5) are not illustrated.

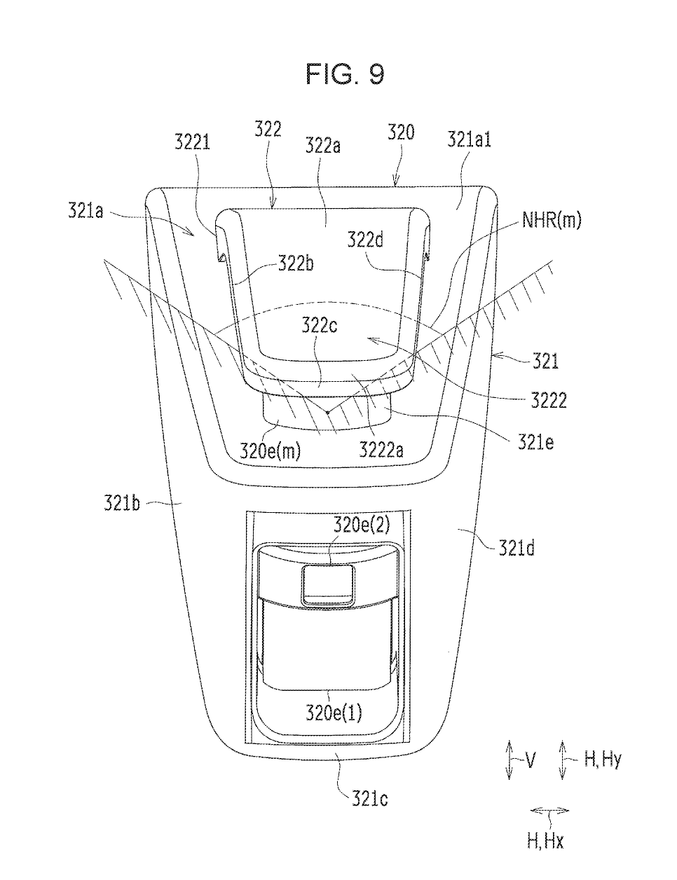

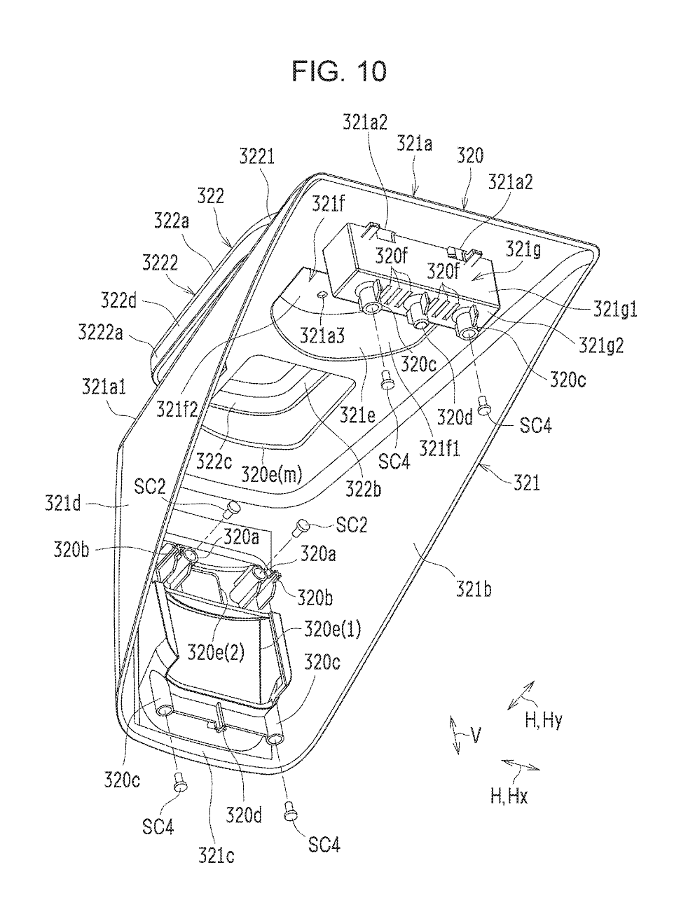

FIG. 9 is a schematic perspective view illustrating the optical detecting unit covering portion 320 as seen in an oblique direction from an upper area on the front surface side and FIG. 10 is a schematic perspective view illustrating the optical detecting unit covering portion 320 as seen in an oblique direction from a lower right area on the rear surface side.

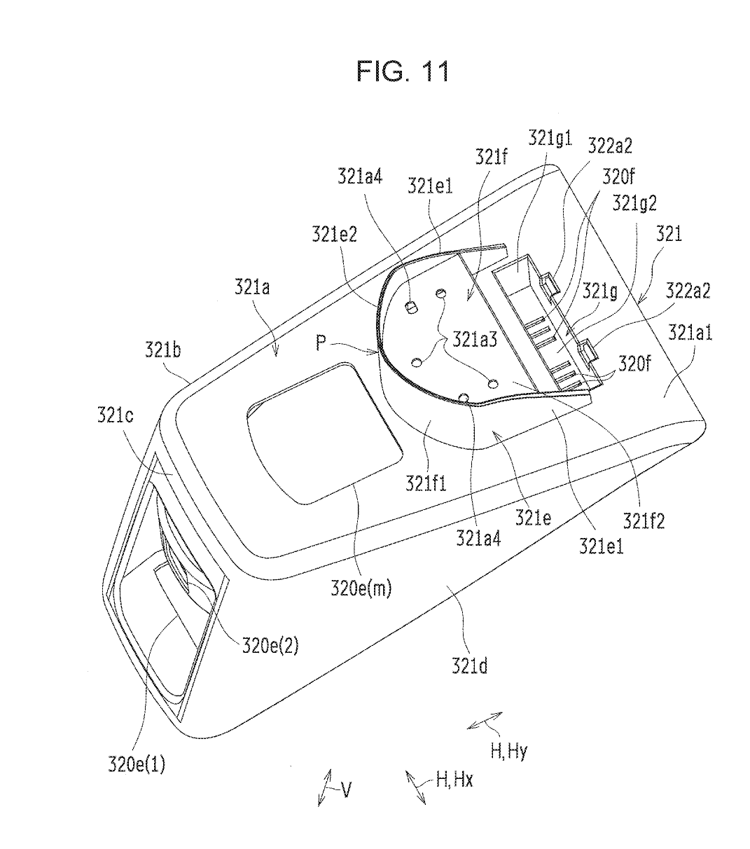

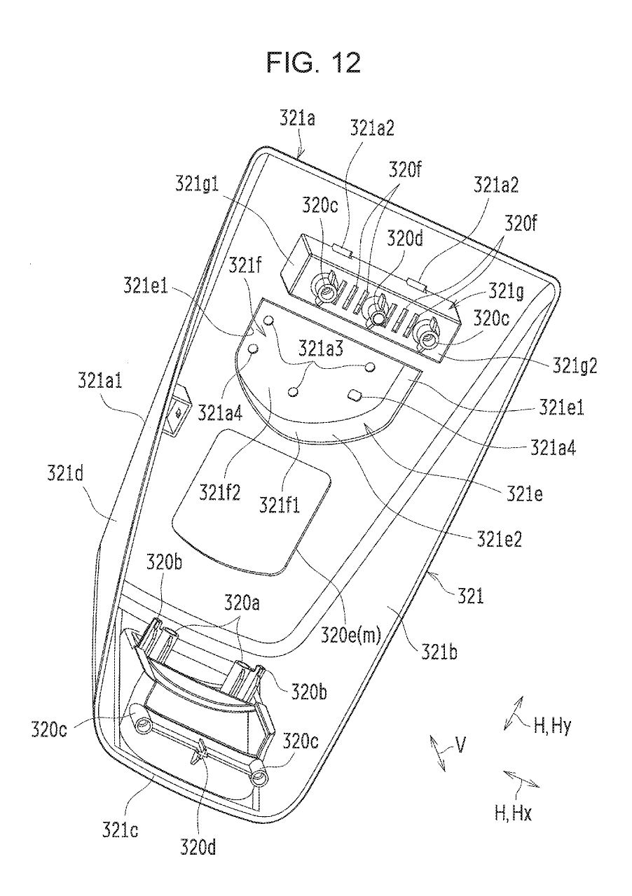

FIG. 11 is a schematic perspective view illustrating the first optical detecting unit covering portion 321 as seen in an oblique direction from a right upper area on the front surface side and FIG. 12 is a schematic perspective view illustrating the first optical detecting unit covering portion 321 as seen in an oblique direction from a lower right area on the rear surface side.

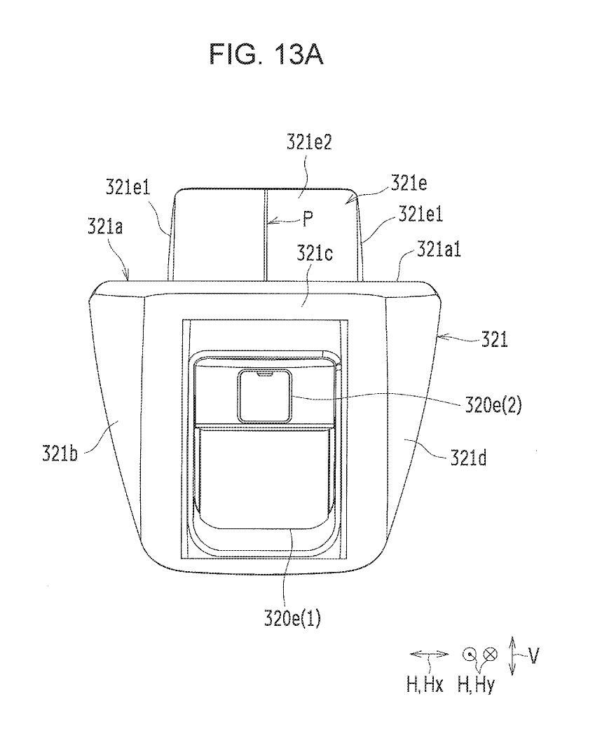

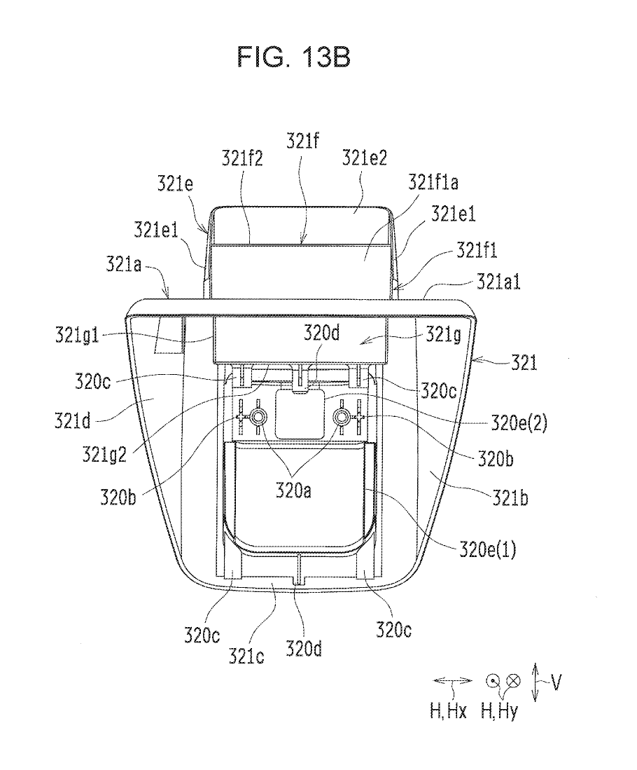

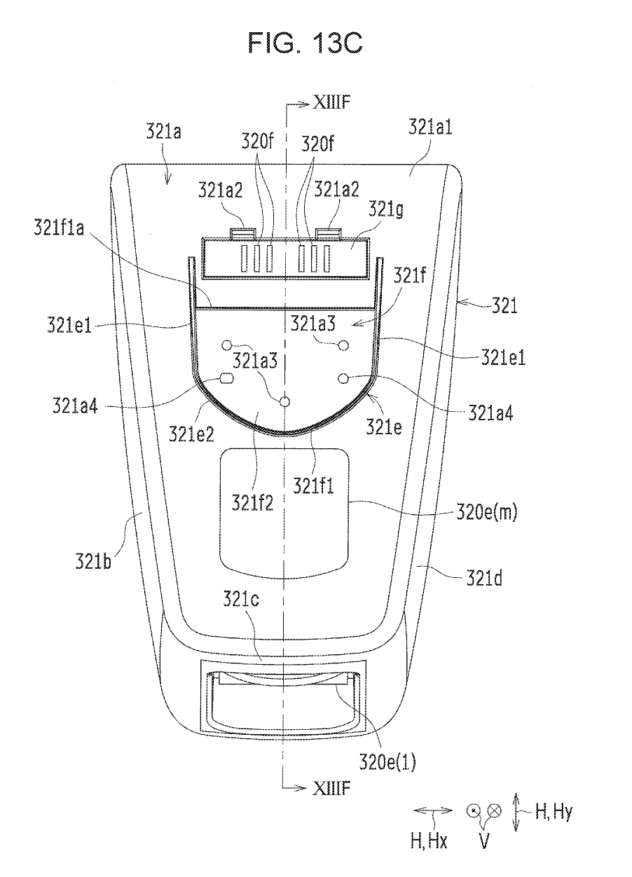

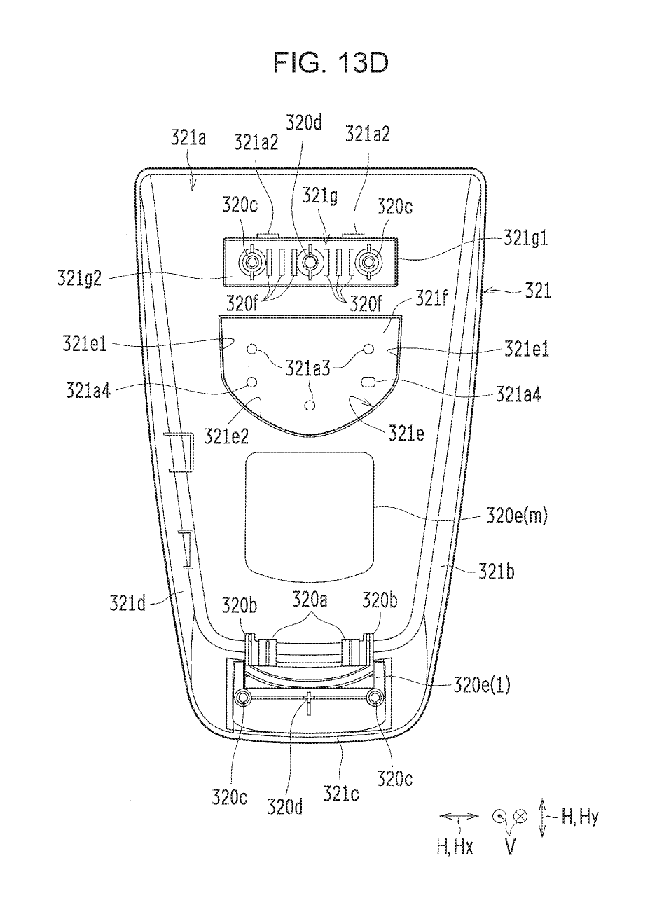

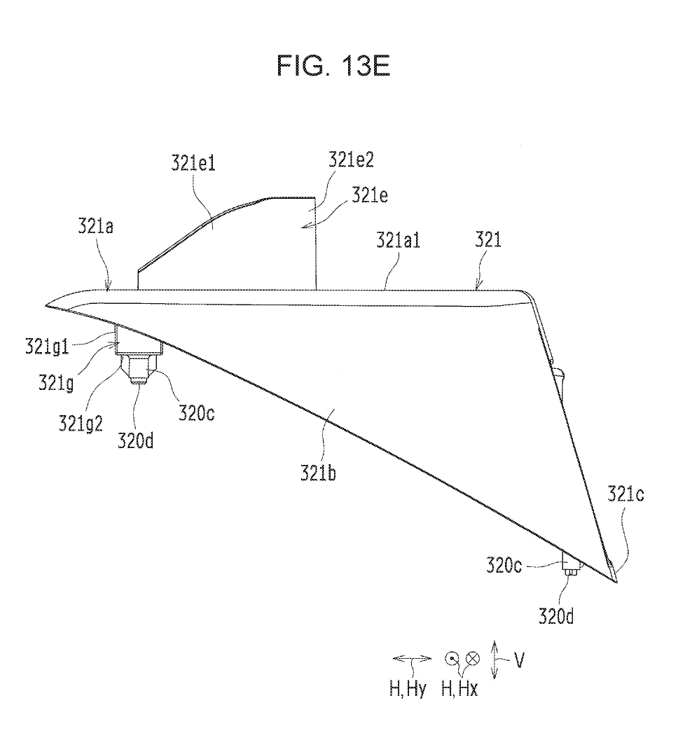

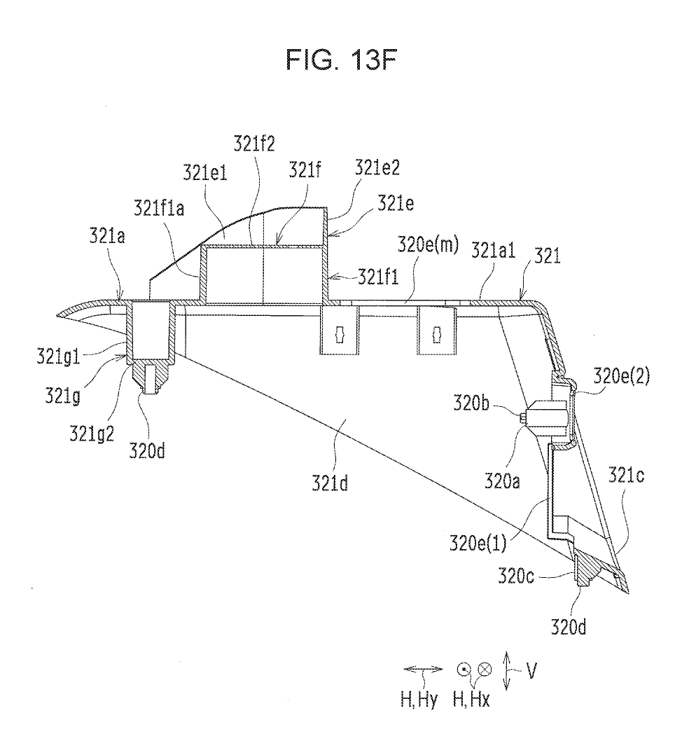

FIGS. 13A to 13E are a front view, a rear view, a top view, a bottom view, and a left side view of the first optical detecting unit covering portion 321, respectively. FIG. 13F is a sectional view of the first optical detecting unit covering portion 321 which is taken along line XIIIF-XIIIF in FIG. 13C. Note that, since a right side view of the first optical detecting unit covering portion 321 is the same as the left side view of the first optical detecting unit covering portion 321, the right side view is not provided.

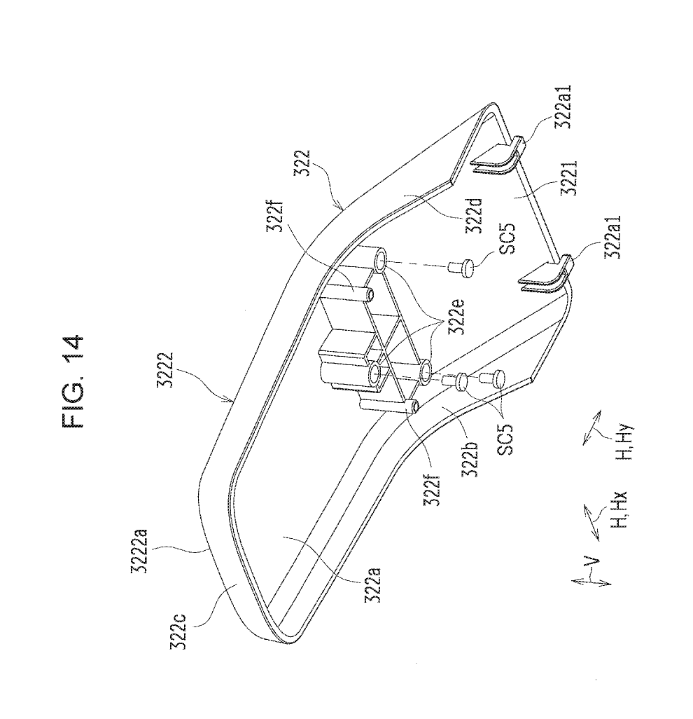

FIG. 14 is a schematic perspective view illustrating a second optical detecting unit covering portion 322 as seen in an oblique direction from a lower right area on the front surface side.

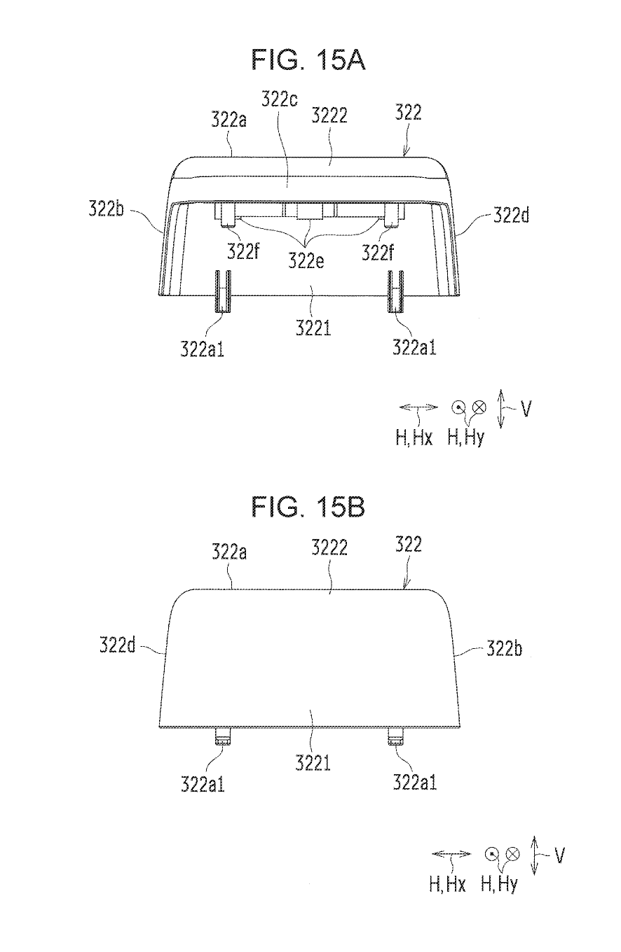

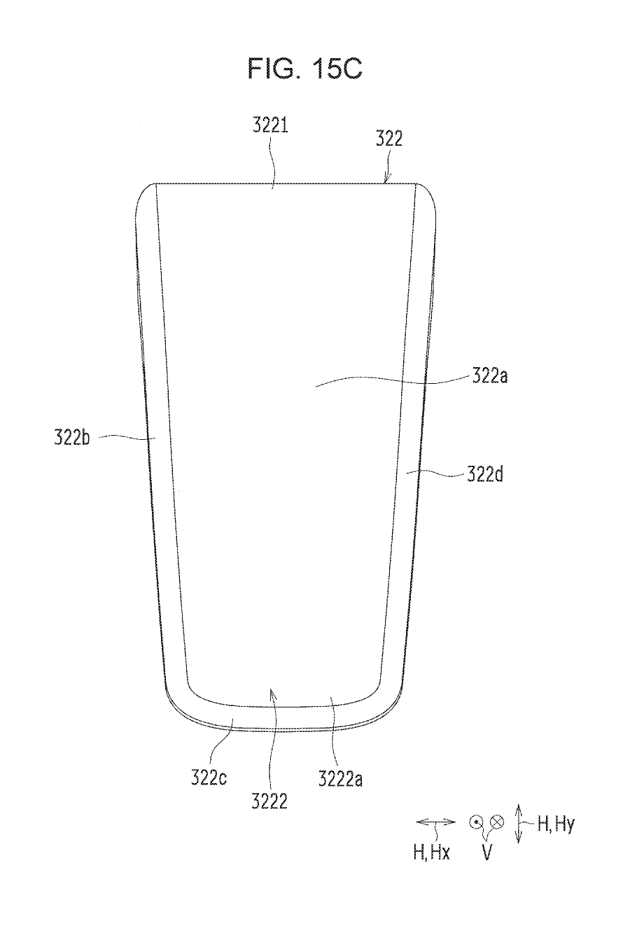

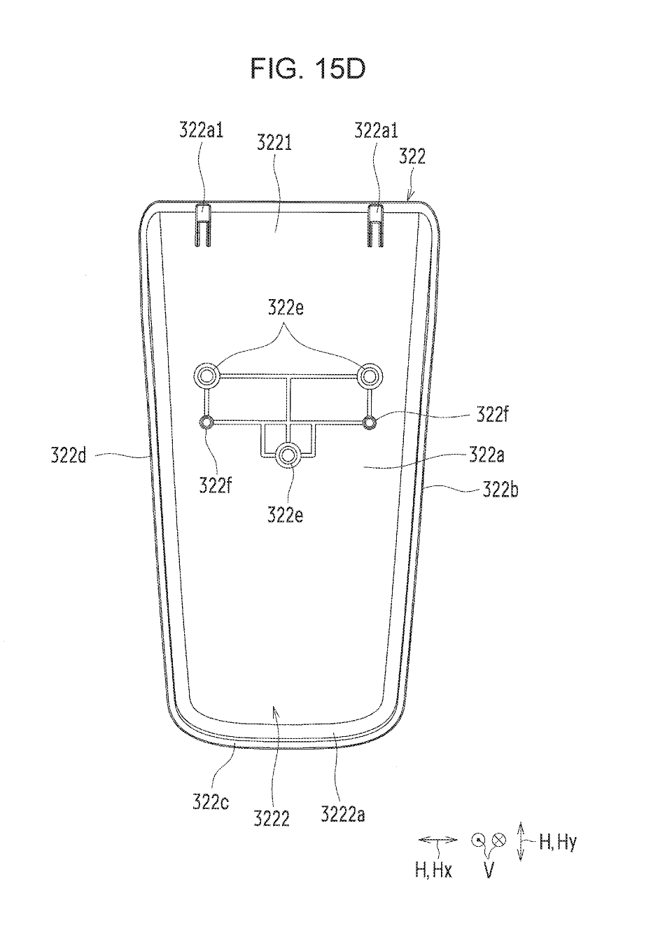

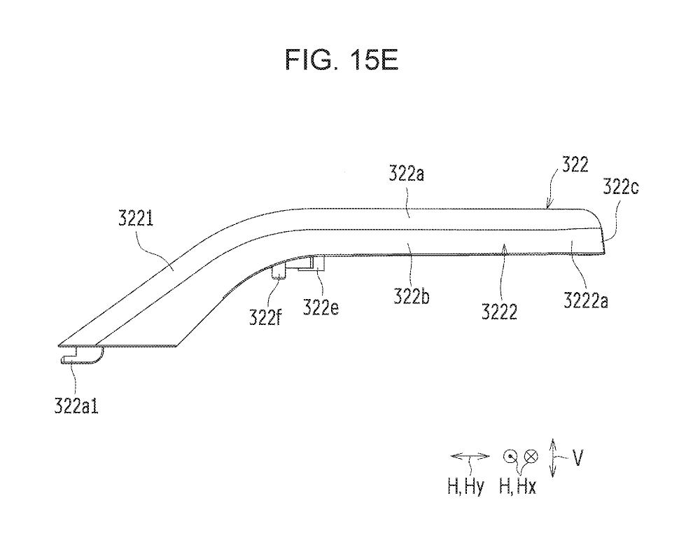

In addition, FIGS. 15A to 15E are a front view, a rear view, a top view, a bottom view, and a left side view of the second optical detecting unit covering portion 322, respectively. Note that, since a right side view of the second optical detecting unit covering portion 322 is the same as the left side view of the second optical detecting unit covering portion 322, the right side view is not provided.

### Cover Member

In the third embodiment, the autonomous traveling apparatus 100 may further include the traveling apparatus body 101 that is provided with the two or more optical detecting units 211 (1) to 211 (m) out of the optical detecting units 211 (1) to 211 (n) (in this example, m=3) arranged in the vertical direction V and the cover member 300 (refer to FIG. 1 and FIGS. 5 to 8) that covers the traveling apparatus body 101.

In a case where the cover member 300 which covers the traveling apparatus body 101 is a single member, the entire cover member 300 is removed when the two or more optical detecting units 211 (1) to 211 (m) are exposed for a maintenance operation for the two or more optical detecting units 211 (1) to 211 (m) or the like. Therefore, there is an adverse influence on the workability in the maintenance operation or the like. Accordingly, it is desirable to improve the workability in the maintenance operation for the like of the two or more optical detecting units 211 (1) to 211 (m).

In this regard, in the third embodiment, the cover member 300 may include a body covering portion 310 (refer to

FIGS. 1 and 5 and FIGS. 6 to 8), which covers a portion of the traveling apparatus body 101 other than a portion of the traveling apparatus body 101 that is provided with the two or more optical detecting units 211 (1) to 211 (m), and the optical detecting unit covering portion 320 (refer to FIGS. 1, 5, 6, 9, and 10), which covers the two or more optical detecting units 211 (1) to 211 (m). In addition, the body covering portion 310 of the cover member 300 and the optical detecting unit covering portion 320 of the cover member 300 may be formed separately from each other.

In this case, it is possible to remove only the optical detecting unit covering portion 320 which is a portion of the cover member 300 and covers the two or more optical detecting units 211 (1) to 211 (m) even when the two or more optical detecting units 211 (1) to 211 (m) are exposed for the maintenance operation for the two or more optical detecting units 211 (1) to 211 (m) or the like. Therefore, it is possible to improve the workability in the maintenance operation or the like for the two or more optical detecting units 211 (1) to 211 (m).

### Fixation of Optical Detecting Unit Covering Portion

Meanwhile, if the optical detecting unit covering portion 320 is attached to the body covering portion 310, there is a decrease in attachment strength of the optical detecting unit covering portion 320. Accordingly, it is desirable to improve the attachment strength of the optical detecting unit covering portion 320.

In this regard, in the third embodiment, the autonomous traveling apparatus 100 may further include an optical detecting unit fixing frame 104 (refer to FIGS. 2 to 6 and FIG. 8) to which two or more optical detecting units 211 (1) to 211 (m) out of the optical detecting units 211 (1) to 211 (n) arranged in the vertical direction V are fixed. The optical detecting unit covering portion 320 (in this example, the first optical detecting unit covering portion 321) may be fixed to the optical detecting unit fixing frame 104.

In this case, it is possible to attach the optical detecting unit covering portion 320 to the optical detecting unit fixing frame 104 having a larger strength than the body covering portion 310. Therefore, it is possible to improve the attachment strength of the optical detecting unit covering portion 320.

Specifically, the traveling apparatus body 101 is provided with a body frame 101a (refer to FIG. 2 and FIGS. 6 to 8). In this example, the body frame 101a constitutes a housing (in this example, a box-shaped housing) of the traveling apparatus body 101.

The body covering portion 310 is attached and fixed to the body frame 101a. A plurality of (in this example, two) fixation tools 101b and 101b (specifically, an equilateral or scalene mountain-shaped steel that constitutes an L-shaped fixation tool (a so-called L-angle)) (refer to FIG. 8) are fixed onto a front surface 101a1 (refer to FIGS. 6 to 8) of the body frame 101a through a fixing method such as welding.

A through hole 101b1 (refer to FIG. 8) along the vertical direction V is provided in each of the fixation tools 101b and 101b. The body covering portion 310 is provided with bosses 310a and 310a (refer to FIG. 8) which are positioned corresponding to the positions of the through holes 101b1 of the fixation tools 101b and 101b, respectively.

The body covering portion 310 is attached to the body frame 101a with a fixation members SC1 and SC1 (refer to FIG. 8) such as screws. The fixation members SC1 and SC1 are fastened to the bosses 310a and 310a of the body covering portion 310 by being inserted into the through holes 101b1 of the fixation tools 101b and 101b fixed to the body frame 101a.

In addition, the optical detecting unit fixing frame 104 extends in the front-rear direction Hy and has a hollow hexahedron shape of which the front surface and the rear surface are open. One side in the vertical direction V (in this example, the lower side) of the front surface of the optical detecting unit fixing frame 104 is inclined frontward so that the area of a bottom surface is larger than the area of a flat surface. The optical detecting unit fixing frame 104 is provided with triangular openings HL1 and HL1 each of which is disposed on the front side of each of a right side plate 104b (refer to FIGS. 6 to 8) and a left side plate 104c (refer to FIGS. 6 to 8), circular openings HL2 to HL2 which are disposed at various positions on the right side plate 104b and the left side plate 104c, and a rectangular opening HL3 which is disposed on the rear side of a top plate 104d (refer to FIGS. 6 to 8) for the purpose of weight reduction.

The rear side end portion of the optical detecting unit fixing frame 104 is fixed to the body frame 101a with fixation members BT such as bolts (refer to FIGS. 7 and 8).

The optical detecting unit 211 (1) is fixed to an upper surface 104e1 (refer to FIG. 8) on the front side of a bottom plate 104e (refer to FIG. 8) of the optical detecting unit fixing frame 104 with a fixation member (not shown) such as a screw.

The optical detecting unit 211 (2) is fixed to one fixation portion 320a or a plurality of (in this example, two) fixation portions 320a and 320a (refer to FIGS. 10, 12, 13B, 13D and 13F) provided on the optical detecting unit covering portion 320 with fixation members SC2 such as screws (refer to FIGS. 8 and 10). The fixation members SC2 are fastened to the fixation portions 320a and 320a of the optical detecting unit covering portion 320 while being inserted into through holes H1 (refer to FIGS. 6 to 8) with which the optical detecting unit 211 (2) is provided. That is, the optical detecting unit 211 (2) is fixed to the optical detecting unit fixing frame 104 via the optical detecting unit covering portion 320. In addition, the optical detecting unit 211 (2) is positioned by one positioning member 320b or a plurality of (in this example, two) positioning members 320b and 320b (refer to FIGS. 10, 12, 13B, 13D, and 13F) provided on the optical detecting unit covering portion 320. The positioning members 320b and 320b are inserted into positioning through holes H2 (refer to FIGS. 6 to 8) with which the optical detecting unit 211 (2) is provided.

The optical detecting unit 211 (3) is fixed to one fixation portion 320a or a plurality of (in this example, two) fixation portions (not shown) provided on the front side of an upper surface 104d1 of the top plate 104d (refer to FIGS. 6 to 8) of the optical detecting unit fixing frame 104 with fixation members SC3 and SC3 such as screws (refer to FIGS. 6 to 8). The fixation members SC3 and SC3 are fastened to the fixation portions of the optical detecting unit fixing frame 104 while being inserted into through holes H3 and H3 (refer to FIGS. 6 to 8) with which the optical detecting unit 211 (3) is provided.

In addition, the optical detecting unit covering portion 320 is provided with one boss 320c or a plurality of (in this example, four) bosses 320c to 320c (refer to FIGS. 10, 12, and 13B, and FIGS. 13D to 13F) to which fixation members SC4 to SC4 such as screws (refer to FIG. 10) are fastened. Fixation portions 104a to 104a (refer to FIG. 8) to which the optical detecting unit covering portion 320 is fixed are provided at positions on the optical detecting unit fixing frame 104 which correspond to the positions of the bosses 320c to 320c of the optical detecting unit covering portion 320. In addition, the optical detecting unit covering portion 320 is provided with one positioning member 320d or a plurality of (in this example, two) positioning members 320d and 320d (refer to FIGS. 10, 12, and 13B and FIGS. 13D to 13F) for positioning the optical detecting unit covering portion 320. The optical detecting unit fixing frame 104 is provided with positioning through holes 104f and 104f (refer to FIG. 8) to which the positioning members 320d and 320d of the optical detecting unit covering portion 320 are inserted.

The positioning members 320d and 320d of the optical detecting unit covering portion 320 having a configuration as described above are inserted into the positioning through holes 104f and 104f provided in the optical detecting unit fixing frame 104. In addition, the fixation members SC4 and SC4 such as screws are fastened to the bosses 320c to 320c while being inserted into fixation portions 104a to 104a provided in the optical detecting unit fixing frame 104. Therefore, it is possible for the optical detecting unit fixing frame 104 to fix the optical detecting unit covering portion 320 in a state where the optical detecting unit covering portion 320 has been positioned.

### Protrusion of Optical Detecting Unit Covering Portion

In the third embodiment, the two or more optical detecting units 211 (1) to 211 (m) out of the optical detecting units 211 (1) to 211 (n) arranged in the vertical direction V may protrude outwards (in this example, upwards) from the traveling apparatus body 101.

Meanwhile, in a case where the two or more optical detecting units 211 (1) to 211 (m) protrude outwards (in this example, upwards) from the traveling apparatus body 101, if the cover member 300 is a single member, the cover member 300 is likely to come into contact with the two or more optical detecting units 211 (1) to 211 (m) when the cover member 300 is attached to the traveling apparatus body 101 and thus the two or more optical detecting units 211 (1) to 211 (m) may be scratched or damaged. Accordingly, it is desirable to suppress the two or more optical detecting units 211 (1) to 211 (m) being scratched or damaged.

In this regard, in the third embodiment, the optical detecting unit covering portion 320 (in this example, the first optical detecting unit covering portion 321) may cover the two or more optical detecting units 211 (1) to 211 (m) which protrude outwards (in this example, upwards) from the body covering portion 310 which is formed separately from the optical detecting unit covering portion 320.

In this case, it is possible to attach the optical detecting unit covering portion 320 after attaching the body covering portion 310 in a state where the two or more optical detecting units 211 (1) to 211 (m) are provided on the traveling apparatus body 101. Accordingly, it is possible to make the optical detecting unit covering portion 320 to be unlikely to come into contact with the two or more optical detecting units 211 (1) to 211 (m) and to suppress the two or more optical detecting units 211 (1) to 211 (m) being scratched or damaged.

Specifically, the traveling apparatus body 101 is formed such that the height of the traveling apparatus body 101 decreases toward the rear side (specifically, the traveling apparatus body 101 is formed to have a linear shape, a curved shape, or a streamline shape). The body covering portion 310 is formed in accordance with the shape of the traveling apparatus body 101. Meanwhile, the optical detecting unit fixing frame 104 is formed to be kept upright with respect to the horizontal direction or a direction approximately parallel to the horizontal direction. Accordingly, the front side of the optical detecting unit fixing frame 104 which protrudes from the traveling apparatus body 101 has a triangular shape or an approximately triangular shape.

### Opening Portion of First Optical Detecting Unit Covering Portion

In addition, the optical detecting unit covering portion 320 includes opening portions 320e (1) to 320e (m) (refer to FIGS. 9 to 12, FIGS. 13A to 13D, and FIG. 13F) for the two or more optical detecting units 211 (1) to 211 (m) out of the optical detecting units 211 (1) to 211 (n) arranged in the vertical direction V. Through the opening portions 320e (1) to 320e (m), the detecting elements (sensors) of the two or more optical detecting units 211 (1) to 211 (m) are exposed so that the detecting elements (sensors) can detect a detection target object.

Therefore, it is possible for the two or more optical detecting units 211 (1) to 211 (m) to reliably detect a detection target object even if the optical detecting unit covering portion 320 covers the two or more optical detecting units 211 (1) to 211 (m).

Specifically, the opening portions 320e (1) to 320e (m) are formed such that the opening portions 320e (1) to 320e (m) do not interrupt the detection ranges HR (1) to HR (m) of the two or more optical detecting units 211 (1) to 211 (m).

### First Optical Detecting Unit Covering Portion and Second Optical Detecting Unit Covering Portion

In the third embodiment, the optical detecting unit covering portion 320 may include the first optical detecting unit covering portion 321 (refer to FIGS. 5 and 6, FIGS. 9 to 12, and FIGS. 13A to 13F) and the second optical detecting unit covering portion 322 (refer to FIGS. 5, 6, 9, 10, and 14 and FIGS. 15A to 15E).

The first optical detecting unit covering portion 321 covers the two or more optical detecting units 211 (1) to 211 (m) provided on the traveling apparatus body 101 except for the entire portion or a portion of a tip end position optical detecting unit 211 (m) (in this example, the two-dimensional Lidar device 211 (3)) (in this example, a portion of the tip end position optical detecting unit 211 (m), specifically, an upper side of the two-dimensional Lidar device 211 (3)) which is an optical detecting unit positioned at a tip end position out of the two or more optical detecting units 211 (1) to 211 (m) provided on the traveling apparatus body 101 (in this example, the first optical detecting unit covering portion 321 covers a lower side of the two-dimensional Lidar device 211 (3), the three-dimensional Lidar device 211 (1), and the imaging camera 211 (2)). The second optical detecting unit covering portion 322 covers the entire portion or a portion of the tip end position optical detecting unit 211 (m) which protrudes outwards (in this example, upwards) from the first optical detecting unit covering portion 321 (in this example, the second optical detecting unit covering portion 322 covers a portion of the tip end position optical detecting unit 211 (m), specifically, the upper side of the two-dimensional Lidar device 211 (3)).

Meanwhile, if the first optical detecting unit covering portion 321 and the second optical detecting unit covering portion 322 are integrally formed with each other, it is difficult to manufacture the optical detecting unit covering portion 320 with ease. Therefore, it is desirable to manufacture the optical detecting unit covering portion 320 with ease.

In this regard, in the third embodiment, the first optical detecting unit covering portion 321 and the second optical detecting unit covering portion 322 may be formed separately from each other.

In this case, it is possible to manufacture the first optical detecting unit covering portion 321 and the second optical detecting unit covering portion 322 separately. Accordingly, it is possible to manufacture the optical detecting unit covering portion 320 with ease.

Specifically, a portion of the tip end position optical detecting unit 211 (m) protrudes outwards (in this example, upwards) from the first optical detecting unit covering portion 321. The first optical detecting unit covering portion 321 is attached and fixed to the optical detecting unit fixing frame 104. The second optical detecting unit covering portion 322 is attached and fixed to the first optical detecting unit covering portion 321.

The first optical detecting unit covering portion 321 includes a first top plate 321a that extends in the horizontal direction or in a direction approximately parallel to the horizontal direction (refer to FIGS. 9 to 12 and FIGS. 13A to 13F), a first left side plate 321b that extends in the vertical direction or in a direction approximately parallel to the vertical direction (refer to FIGS. 9 to 12 and FIGS. 13A to 13E), a first front surface plate 321c of which one side in the vertical direction V (in this example, the lower side) is inclined frontward (refer to FIGS. 9 to 12 and FIGS. 13A to 13F), and a first right side plate 321d that extends in the vertical direction or in a direction approximately parallel to the vertical direction (refer to FIGS. 9 to 12, FIGS. 13A to 13D, and FIG. 13F).

The first top plate 321a passes through an upper side of the tip end position optical detecting unit 211 (m) and covers a lower side of the tip end position optical detecting unit 211 (m) and the optical detecting units 211 (1) to 211 (m-1) while being positioned above the lower side of the tip end position optical detecting unit 211 (m) and the optical detecting units 211 (1) to 211 (m-1). The first left side plate 321b, the first front surface plate 321c, the first right side plate 321d covers the lower side of the tip end position optical detecting unit 211 (m) and the optical detecting units 211 (1) to 211 (m-1) while being positioned on the left side, the front side, and the right side of the lower side of the tip end position optical detecting unit 211 (m) and the optical detecting units 211 (1) to 211 (m-1), respectively.

The first left side plate 321b and the first right side plate 321d are formed such that a gap therebetween becomes larger toward the rear side.

The first top plate 321a, the first left side plate 321b, the first front surface plate 321c, and the first right side plate 321d are integrally formed with each other to constitute the first optical detecting unit covering portion 321. In addition, the first front surface plate 321c is provided with the opening portions 320e (1) and 320e (2) for the optical detecting units 211 (1) and 211 (2) which penetrate the first front surface plate 321c in the front-rear direction Hy and the first top plate 321a is provided with the opening portion 320e (m) for the optical detecting unit 211 (m) which penetrates the first top plate 321a in the vertical direction V.

The second optical detecting unit covering portion 322 includes a second top plate 322a that extends in the horizontal direction or in a direction approximately parallel to the horizontal direction (refer to FIGS. 9, 10, and 14 and FIGS. 15A to 15E), a second left side plate 322b that extends in the vertical direction or in a direction approximately parallel to the vertical direction (refer to FIGS. 9, 10, and 14 and FIGS. 15A to 15E), a second front surface plate 322c that extends in the vertical direction or in a direction approximately parallel to the vertical direction (refer to FIGS. 9, 10, 14, and 15A and FIGS. 15C to 15E), and a second right side plate 322d that extends in the vertical direction or in a direction approximately parallel to the vertical direction (refer to FIGS. 9, 10, and 14 and FIGS. 15A to 15D).

The second top plate 322a covers the upper side (specifically, an upper surface 2111 (refer to FIGS. 7 and 8)) of the tip end position optical detecting unit 211 (m) while being positioned above the tip end position optical detecting unit 211 (m). The second left side plate 322b, the second front surface plate 322c, the second right side plate 322d covers the upper side of the tip end position optical detecting unit 211 (m) while being positioned on the left side, the front side, and the right side of the upper side of the tip end position optical detecting unit 211 (m), respectively.

The second top plate 322a, the second left side plate 322b, the second front surface plate 322c, and the second right side plate 322d are integrally formed with each other to constitute the second optical detecting unit covering portion 322.

### Disposed Position of Second Optical Detecting Unit Covering Portion

In the third embodiment, the tip end position optical detecting unit 211 (m) may have a detection range HR (m) (in this example, HR (3)) in which a detection target object is detected and a non-detection range NHR (m) (in this example, NHR (3)) in which the detection target object is not detected (refer to FIGS. 5 and 9).

Meanwhile, if the second optical detecting unit covering portion 322 is provided within the detection range HR (m) of the tip end position optical detecting unit 211 (m), the second optical detecting unit covering portion 322 interrupts a detecting operation of the tip end position optical detecting unit 211 (m) with the second optical detecting unit covering portion 322 being positioned within the detection range HR (m) of the tip end position optical detecting unit 211 (m). Therefore, it is desirable to restrict the second optical detecting unit covering portion 322 from interrupting the detecting operation of the tip end position optical detecting unit 211 (m).

In this regard, in the third embodiment, the second optical detecting unit covering portion 322 may be provided to extend toward the upper surface 2111 of the tip end position optical detecting unit 211 (m) from the first optical detecting unit covering portion 321 in the non-detection range NHR (m) of the tip end position optical detecting unit 211 (m).

In this case, it is possible to restrict the second optical detecting unit covering portion 322 from being positioned within the detection range HR (m) of the tip end position optical detecting unit 211 (m). Therefore, it is possible to restrict the second optical detecting unit covering portion 322 from interrupting the detecting operation of the tip end position optical detecting unit 211 (m).

Specifically, the second optical detecting unit covering portion 322 is positioned at the central position or the approximately central position in the horizontal direction H of the non-detection range NHR (m) of the tip end position optical detecting unit 211 (m).

The second optical detecting unit covering portion 322 includes a first covering portion 3221 which is provided to extend toward the upper surface 2111 of the tip end position optical detecting unit 211 (m) from the first optical detecting unit covering portion 321 (refer to FIGS. 6, 9, 10, and 14 and FIGS. 15A to 15E) and a second covering portion 3222 which continues from the first covering portion 3221 and covers the tip end position optical detecting unit 211 (m) in a state of being placed on the upper surface 2111 of the tip end position optical detecting unit 211 (m) (refer to FIGS. 6, 9, 10, and 14 and FIGS. 15A to 15E). The first covering portion 3221 is inclined with respect to the first optical detecting unit covering portion 321 while extending in a frontward oblique direction W (refer to FIG. 6). The first covering portion 3221 and the second covering portion 3222 are integrally formed with each other to constitute the second optical detecting unit covering portion 322.

### Roof Function of Second Optical Detecting Unit Covering Portion

Meanwhile, since the tip end position optical detecting unit 211 (m) is an optical detecting unit positioned at a tip end position out of the two or more optical detecting units 211 (1) to 211 (m) provided on the traveling apparatus body 101, if the autonomous traveling apparatus 100 is operated in an environment such as an outdoor environment in which water may fall onto the autonomous traveling apparatus 100, water droplets such as rain are likely to adhere to the tip end position optical detecting unit 211 (m). Therefore, it is desirable to make water droplets such as rain be unlikely to adhere to the tip end position optical detecting unit 211 (m) even in a case where the autonomous traveling apparatus 100 is operated in an environment such as an outdoor environment in which water may fall onto the autonomous traveling apparatus 100.

In this regard, in the third embodiment, the second optical detecting unit covering portion 322 may include a projecting portion 3222a that projects outwards in the horizontal direction H from the upper surface 2111 of the tip end position optical detecting unit 211 (m) (refer to FIGS. 6, 9, 10, and 14 and FIGS. 15C to 15E).

In this case, it is possible to cause the projecting portion 3222a of the second optical detecting unit covering portion 322 which projects outwards in the horizontal direction H from the upper surface 2111 of the tip end position optical detecting unit 211 (m) to function as a roof. Therefore, it is possible to make water droplets such as rain be unlikely to adhere to the tip end position optical detecting unit 211 (m) even in a case where the autonomous traveling apparatus 100 is operated in an environment such as an outdoor environment in which water may fall onto the autonomous traveling apparatus 100.

Specifically, the projecting portion 3222a of the second covering portion 3222 constitutes a roof that projects outwards in the horizontal direction H from the upper surface 2111 of the tip end position optical detecting unit 211 (m) by a predetermined distance which is determined in advance. Fixation of Second Optical Detecting Unit Covering Portion

Meanwhile, even in a case where the second optical detecting unit covering portion 322 is provided to extend toward the upper surface 2111 of the tip end position optical detecting unit 211 (m) from the first optical detecting unit covering portion 321, there is still a possibility that the attachment strength of the second optical detecting unit covering portion 322 with respect to the first optical detecting unit covering portion 321 may decrease. Therefore, it is desirable to improve the attachment strength of the second optical detecting unit covering portion 322 with respect to the first optical detecting unit covering portion 321.

In this regard, in the third embodiment, the first optical detecting unit covering portion 321 may include a body portion 321a1 (refer to FIGS. 9 to 12, FIGS. 13A to 13C, and FIGS. 13E and 13F) and a protrusion portion 321e (refer to FIGS. 9 to 12 and FIGS. 13A to 13F) that protrudes from the body portion 321a1 in the non-detection range NHR (m) in the horizontal direction H of the tip end position optical detecting unit 211 (m). The second optical detecting unit covering portion 322 may be fixed to the body portion 321a1 of the first optical detecting unit covering portion 321 in a state of being supported by the protrusion portion 321e of the first optical detecting unit covering portion 321.

In this case, it is possible to reinforce the second optical detecting unit covering portion 322 with the protrusion portion 321e. Therefore, it is possible to improve the attachment strength of the second optical detecting unit covering portion 322 with respect to the first optical detecting unit covering portion 321.

Specifically, the body portion 321a1 is a flat surface-shaped covering portion. The body portion 321a1 extends in the horizontal direction H or in a direction approximately parallel to the horizontal direction H. The protrusion portion 321e is erected on the body portion 321a1 at the right angle or an approximately right angle. The protrusion portion 321e includes a pair of first protrusion portions 321e1 and 321e1 (refer to FIGS. 11 and 12 and FIGS. 13A to 13F), which have a linear shape and are formed such that a gap therebetween becomes larger toward the rear side, and a second protrusion portion 321e2 (refer to FIGS. 11 and 12 and FIGS. 13A to 13F), which has an arc shape or a curved shape and continues from each of the pair of first protrusion portions 321e1 and 321e1 and of which the front side has a convex shape. The protrusion portion 321e is provided such that a vertex P of the arc shape or the curved shape of the second protrusion portion 321e2 faces frontwards (refer to FIGS. 11 and 13A).

The pair of first protrusion portions 321e1 and 321e1 and the second protrusion portion 321e2 are integrally formed with each other to constitute the protrusion portion 321e. The body portion 321a1 and the protrusion portion 321e are integrally formed with each other to constitute the first top plate 321a.

A rear side end portion of the second optical detecting unit covering portion 322 (in this example, the second top plate 322a) is locked onto the first optical detecting unit covering portion 321 (in this example, the first top plate 321a).

The rear side end portion of the second optical detecting unit covering portion 322 (in this example, the second top plate 322a) is provided with one engaging claw 322a1 or a plurality of (in this example, two) engaging claws 322a1 and 322a1 (refer to FIGS. 14, 15A, 15B, 15D, and 15E). Each of the engaging claws 322a1 and 322a1 extends from the second optical detecting unit covering portion 322 (in this example, the second top plate 322a) toward the bottom surface side (the lower side) and the middle portion thereof is curved toward the rear side and the middle portion has an L-like shape (in this example, the middle portion is curved at the right angle or an approximately right angle). The rear side end portion of the first optical detecting unit covering portion 321 (in this example, the first top plate 321a) is provided with lock portions 321a2 and 321a2 (in this example, lock through holes) in which the engaging claws 322a1 and 322a1 are locked (refer to FIGS. 10, 11, 12, 13C, and 13D).

The second optical detecting unit covering portion 322 is fixed to the first optical detecting unit covering portion 321 in the horizontal direction H via the engaging claws 322a1 and 322a1. The engaging claws 322a1 and 322a1 are locked while being inserted into the lock portions 321a2 and 321a2 provided in the first optical detecting unit covering portion 321.

The second optical detecting unit covering portion 322 (in this example, the second top plate 322a) is provided with one fixation portion 322e or a plurality of (in this example, three) fixation portions 322e to 322e (refer to FIGS. 14, 15A, 15D, and 15E). Fixation members SC5 to SC5 (refer to FIG. 14) such as screws are fastened to the fixation portions 322e to 322e. The first optical detecting unit covering portion 321 (in this example, the first top plate 321a) is provided with through holes 321a3 to 321a3 (refer to FIGS. 10 to 12 and FIGS. 12, 13C, and 13D) corresponding to the fixation portions 322e to 322e. In addition, the second optical detecting unit covering portion 322 (in this example, the second top plate 322a) is provided with one positioning member 322f or a plurality of (in this example, two) positioning members 322f and 322f (refer to FIGS. 14, 15A, 15D, and 15E). The first optical detecting unit covering portion 321 (in this example, the first top plate 321a) is provided with positioning through holes 321a4 to 321a4 (refer to FIGS. 11, 12, 13C, and 13D) corresponding to the positioning members 322f and 322f.

The second optical detecting unit covering portion 322 is attached and fixed to the first optical detecting unit covering portion 321 with the fixation members SC5 to SC5 such as screws. The fixation members SC5 to SC5 are fastened to the fixation portions 322e to 322e while being inserted into the through holes 321a3 to 321a3 provided in the first optical detecting unit covering portion 321. In addition, the second optical detecting unit covering portion 322 is positioned by the positioning members 322f and 322f. The positioning members 322f and 322f are inserted into the positioning through holes 321a4 to 321a4 provided in the first optical detecting unit covering portion 321. Shape of First Optical Detecting Unit Covering Portion

Meanwhile, in a case where the size (in this example, the size in the horizontal direction H) of a portion of the first optical detecting unit covering portion 321 which is close to the traveling apparatus body 101 is equal to or smaller than the size (in this example, the size in the horizontal direction H) of a portion of the first optical detecting unit covering portion 321 which is distant from the traveling apparatus body 101, it is desirable to attach the first optical detecting unit covering portion 321 while paying attention to restrict the first optical detecting unit covering portion 321 from coming into contact with the two or more optical detecting units 211 (1) to 211 (m) in a state where the two or more optical detecting units 211 (1) to 211 (m) are provided on the traveling apparatus body 101. This is because the first optical detecting unit covering portion 321 is likely to come into contact with the two or more optical detecting units 211 (1) to 211 (m) and the two or more optical detecting units 211 (1) to 211 (m) are likely to be scratched or damaged. Therefore, it is desirable to suppress the two or more optical detecting units 211 (1) to 211 (m) being scratched or damaged.

In this regard, in the third embodiment, the first optical detecting unit covering portion 321 may have a trapezoidal shape or an approximately trapezoidal shape and the size (in this example, the size in the horizontal direction H) of a portion of the first optical detecting unit covering portion 321 which is close to the traveling apparatus body 101 may be larger than the size (in this example, the size in the horizontal direction H) of a portion of the first optical detecting unit covering portion 321 which is distant from the traveling apparatus body 101.

In this case, it is possible to make the first optical detecting unit covering portion 321 be unlikely to come into contact with the two or more optical detecting units 211 (1) to 211 (m) when attaching the first optical detecting unit covering portion 321 to the traveling apparatus body 101 which is provided with the two or more optical detecting units 211 (1) to 211 (m) and to suppress the two or more optical detecting units 211 (1) to 211 (m) being scratched or damaged.

Specifically, the first optical detecting unit covering portion 321 is formed to have an isosceles trapezoid shape or an approximately isosceles trapezoid shape as seen from a predetermined direction (in this example, from the front surface side). The first left side plate 321b and the first right side plate 321d of the first optical detecting unit covering portion 321 are formed such that a gap therebetween becomes smaller from one side in the vertical direction V (in this example, the lower side) toward the other side in the vertical direction V (in this example, the upper side). In addition, the first optical detecting unit covering portion 321 is formed to have a trapezoidal shape or an approximately isosceles trapezoidal shape as seen from a predetermined direction (in this example, from the right surface side or the left surface side). One side of the first front surface plate 321c in the vertical direction V (in this example, the lower side) is inclined frontwards.

### Bases of First Optical Detecting Unit Covering Portion

Meanwhile, in a case where the first optical detecting unit covering portion 321 is fixed to the optical detecting unit fixing frame 104 and the second optical detecting unit covering portion 322 is fixed to the first optical detecting unit covering portion 321, a distance between the first optical detecting unit covering portion 321 and the fixation portions 104a to 104a of the optical detecting unit fixing frame 104 and a distance between the first optical detecting unit covering portion 321 and the fixation portions 322e to 322e of the second optical detecting unit covering portion 322 are likely to become long. Therefore, it is desirable to extend the fixation portions 104a to 104a of the optical detecting unit fixing frame 104 toward the first optical detecting unit covering portion 321 side and it is desirable to extend the fixation portions 322e to 322e of the second optical detecting unit covering portion 322 to the first optical detecting unit covering portion 321 side. In this case, the strengths of the fixation portions 104a to 104a of the optical detecting unit fixing frame 104 and the fixation portions 322e to 322e of the second optical detecting unit covering portion 322 are likely to decrease. Therefore, it is desirable to improve the strengths of the fixation portions 104a to 104a of the optical detecting unit fixing frame 104 and the fixation portions 322e to 322e of the second optical detecting unit covering portion 322.

In this regard, in the third embodiment, the first optical detecting unit covering portion 321 may be provided with a first base 321f (refer to FIGS. 10 to 12, FIGS. 13B to 13D, and FIG. 13F) that reduces a distance between the first optical detecting unit covering portion 321 and the fixation portions 322e to 322e of the second optical detecting unit covering portion 322 and a second base 321g (refer to FIGS. 10 to 12 and FIGS. 13B to 13F) that reduces a distance between the first optical detecting unit covering portion 321 and the fixation portions 104a to 104a of the optical detecting unit fixing frame 104.

In this case, it is possible to restrict the fixation portions 104a to 104a of the optical detecting unit fixing frame 104 from extending toward the first optical detecting unit covering portion 321 side or to suppress the fixation portions 104a of the optical detecting unit fixing frame 104 extending toward the first optical detecting unit covering portion 321 side and it is possible to restrict the fixation portions 322e to 322e of the second optical detecting unit covering portion 322 from extending toward the first optical detecting unit covering portion 321 side or to suppress the fixation portions 322e of the second optical detecting unit covering portion 322 extending toward the first optical detecting unit covering portion 321 side. Therefore, it is possible to improve the strengths of the fixation portions 104a to 104a of the optical detecting unit fixing frame 104 and the fixation portions 322e to 322e of the second optical detecting unit covering portion 322.

Specifically, the first base 321f is a protrusion portion that protrudes toward the second optical detecting unit covering portion 322 side (refer to FIGS. 11, 13B, and 13F). The first base 321f is a recess portion as seen from the optical detecting unit fixing frame 104 side (refer to FIGS. 10, 12, and 13F). The first base 321f includes a first erected portion 321f1 (refer to FIGS. 10 to 12 and FIGS. 13B, 13C, and 13F) that is erected on the first optical detecting unit covering portion 321 (in this example, the first top plate 321a) at the right angle or an approximately right angle and a first flat surface portion 321f2 (refer to FIGS. 10 to 12 and FIGS. 13B, 13C, and 13F) that continues from the first erected portion 321f1 and extends in the horizontal direction H or a direction approximately parallel to the horizontal direction H. The first erected portion 321f1 and the first flat surface portion 321f2 are integrally formed with each other to constitute the first base 321f.

The front side of the first erected portion 321f1 of the first base 321f constitutes the second protrusion portion 321e2 and the right and left sides of the first erected portion 321f1 constitute a portion of the pair of first protrusion portions 321e1 and 321e1. The rear side of the first erected portion 321f1 is provided with a connection portion 321f1a (refer to FIGS. 13B, 13C, and 13F) that is formed to extend in the transverse direction Hx and connects the pair of first protrusion portions 321e1 and 321e1 to each other.

The first flat surface portion 321f2 of the first base 321f is provided with the through holes 321a3 to 321a3 and the positioning through holes 321a4 to 321a4.

In addition, the second base 321g is a protrusion portion that protrudes toward the optical detecting unit fixing frame 104 side (refer to FIGS. 10, 12, 13B, 13E and 13F). The second base 321g is a recess portion as seen from the second optical detecting unit covering portion 322 side (refer to FIGS. 11 and 13F). The second base 321g includes a second erected portion 321g1 (refer to FIGS. 10 to 12, FIG. 13B, and FIGS. 13D to 13F) that is erected on the first optical detecting unit covering portion 321 (in this example, the first top plate 321a) at the right angle or an approximately right angle and a second flat surface portion 321g2 (refer to FIGS. 10 to 12, FIG. 13B, and FIGS. 13D to 13F) that continues from an end portion of the second erected portion 321g1 and extends in the horizontal direction H or a direction approximately parallel to the horizontal direction H. The second erected portion 321g1 and the second flat surface portion 321g2 are integrally formed with each other to constitute the second base 321g. The second base 321g is provided close to the rear side end portions of the pair of first protrusion portions 321e1 and 321e1 of the protrusion portion 321e (refer to FIGS. 11 and 13C).

The second base 321g has a rectangular parallelepiped-like shape. That is, each of the second erected portion 321g1 and the second flat surface portion 321g2 of the second base 321g has a square shape or a rectangular shape.

The bosses 320c to 320c and the positioning members 320d and 320d are provided on a portion of the second flat surface portion 321g2 of the second base 321g which is close to the optical detecting unit fixing frame 104 side. In addition, the second flat surface portion 321g2 is provided with a plurality of through holes 320f to 320f (specifically, drain holes) (refer to FIGS. 10 to 12 and FIGS. 13C and 13D) for causing water droplets such as rain to fall downwards. Here, a portion of the autonomous traveling apparatus 100 which is below the second base 321g is configured not to be adversely affected by the falling of water droplets such as rain.

The disclosure is not limited to the above-described embodiments and can be implemented in various forms which are different from the above-described embodiments. Therefore, the above-described embodiments are merely an example in every respect and are not to be construed as limiting the scope of the disclosure. The scope of the disclosure is defined by the claims and is not restricted by the description in the specification. All modifications and changes within the range of equivalents of the claims are within the scope of the present disclosure.

The present disclosure contains subject matter related to that disclosed in Japanese Priority Patent Application JP 2016-173690 filed in the Japan Patent Office on Sep. 6, 2016, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An autonomous traveling apparatus comprising:
a detecting device that is provided with a plurality of optical detecting units each of which detects a detection target object by using light,
wherein the autonomous traveling apparatus autonomously travels while detecting the detection target object by using the detecting device, and
wherein at least two optical detecting units out of the plurality of optical detecting units are arranged in a vertical direction.

2. The autonomous traveling apparatus according to claim 1,
wherein two or more optical detecting units out of the optical detecting units arranged in the vertical direction are different from each other in detecting structure for detecting the detection target object.

3. The autonomous traveling apparatus according to claim 1,
wherein two or more optical detecting units out of the optical detecting units arranged in the vertical direction are arranged such that detection ranges thereof in a horizontal direction become wider from one side toward the other side in the vertical direction.

4. The autonomous traveling apparatus according to claim 3,
wherein the two or more optical detecting units are arranged such that detection ranges thereof in the horizontal direction become wider from a lower side toward an upper side.

5. The autonomous traveling apparatus according to claim 3,
wherein central positions or approximately central positions of the detection ranges in the horizontal direction of the two or more optical detecting units are aligned with each other in the vertical direction.

6. The autonomous traveling apparatus according to claim 1,
wherein the optical detecting units arranged in the vertical direction include two Lidar devices and an imaging camera, and
wherein the imaging camera is disposed between the two Lidar devices.

7. The autonomous traveling apparatus according to claim 6,
wherein the two Lidar devices are a three-dimensional Lidar device and a two-dimensional Lidar device, and
wherein the three-dimensional Lidar device, the imaging camera, and the two-dimensional Lidar device are arranged in this order in a direction from the lower side to the upper side such that detection ranges thereof in the horizontal direction become wider from a lower side toward an upper side.

8. The autonomous traveling apparatus according to claim 6,
wherein the optical detecting units arranged in the vertical direction further include an infrared camera and an omnidirectional camera, and
wherein the infrared camera and the omnidirectional camera are provided above an optical detecting unit other than the infrared camera and the omnidirectional camera out of the optical detecting units arranged in the vertical direction.

9. The autonomous traveling apparatus according to claim 8,
wherein the infrared camera and the omnidirectional camera are arranged in this order in a direction from the lower side to the upper side.

10. The autonomous traveling apparatus according to claim 8, further comprising:
a traveling apparatus body that is provided with two or more optical detecting units out of the optical detecting units arranged in the vertical direction;
a lifting and lowering table; and
a lifting and lowering device that lifts and lowers the lifting and lowering table with respect to the traveling apparatus body,
wherein the infrared camera and the omnidirectional camera are provided on the lifting and lowering table.

11. The autonomous traveling apparatus according to claim 1, further comprising:
a traveling apparatus body that is provided with two or more optical detecting units out of the optical detecting units arranged in the vertical direction; and
a cover member that covers the traveling apparatus body,
wherein the cover member includes a body covering portion, which covers a portion of the traveling apparatus body other than a portion of the traveling apparatus body that is provided with the two or more optical detecting units, and an optical detecting unit covering portion, which covers the two or more optical detecting units, the body covering portion and the optical detecting unit covering portion being formed separately from each other.

12. The autonomous traveling apparatus according to claim 11, further comprising:
an optical detecting unit fixing frame to which two or more optical detecting units out of the optical detecting units arranged in the vertical direction are fixed,
wherein the optical detecting unit covering portion is fixed to the optical detecting unit fixing frame.

13. The autonomous traveling apparatus according to claim 11,
wherein the two or more optical detecting units out of the optical detecting units arranged in the vertical direction protrude outwards from the traveling apparatus body, and
wherein the optical detecting unit covering portion covers the two or more optical detecting units which protrude outwards from the body covering portion which is formed separately from the optical detecting unit covering portion.

14. The autonomous traveling apparatus according to claim 13,
wherein the optical detecting unit covering portion includes a first optical detecting unit covering portion, which covers the two or more optical detecting units provided on the traveling apparatus body except for the entire portion or a portion of a tip end position optical detecting unit which is an optical detecting unit positioned at a tip end position out of the two or more optical detecting units provided on the traveling apparatus body, and a second optical detecting unit covering portion, which covers the entire portion or a portion of the tip end position optical detecting unit which protrudes outwards from the first optical detecting unit covering portion, the first optical detecting unit covering portion and the second optical detecting unit covering portion being formed separately from each other.

15. The autonomous traveling apparatus according to claim 14,
wherein the tip end position optical detecting unit has a non-detection range in which the detection target object is not detected, and
wherein the second optical detecting unit covering portion is provided to extend toward an upper surface of the tip end position optical detecting unit from the first optical detecting unit covering portion in the non-detection range of the tip end position optical detecting unit.

16. The autonomous traveling apparatus according to claim 15,
wherein the second optical detecting unit covering portion includes a projecting portion that projects outwards in the horizontal direction from the upper surface of the tip end position optical detecting unit.

17. The autonomous traveling apparatus according to claim 15,
wherein the first optical detecting unit covering portion includes a body portion and a protrusion portion that protrudes from the body portion in the non-detection range in the horizontal direction of the tip end position optical detecting unit, and
wherein the second optical detecting unit covering portion is fixed to the body portion of the first optical detecting unit covering portion in a state of being supported by the protrusion portion of the first optical detecting unit covering portion.

18. The autonomous traveling apparatus according to claim 14,
wherein the first optical detecting unit covering portion has a trapezoidal shape or an approximately trapezoidal shape and the size of a portion of the first optical detecting unit covering portion which is close to the traveling apparatus body is larger than the size of a portion of the first optical detecting unit covering portion which is distant from the traveling apparatus body.

19. The autonomous traveling apparatus according to claim 14, further comprising:
an optical detecting unit fixing frame to which two or more optical detecting units out of the optical detecting units arranged in the vertical direction are fixed,
wherein the first optical detecting unit covering portion is fixed to the optical detecting unit fixing frame, and
wherein the first optical detecting unit covering portion is provided with a first base that reduces a distance between the first optical detecting unit covering portion and a fixation portion of the second optical detecting unit covering portion and a second base that reduces a distance between the first optical detecting unit covering portion and a fixation portion of the optical detecting unit fixing frame.
